(19) United States
(12) Patent Application Publication
(10) Pub. No.: US 2015/0186875 A1
(43) Pub. Date: Jul. 2, 2015

(54) Information Configuration Method, Device, System, Client And Server

(71) Applicant: Tencent Technology (Shenzhen) Company Limited, Shenzhen (CN)

(72) Inventors: Xiaolong ZHANG, Shenzhen (CN); Wa YE, Shenzhen (CN); Peng LlU, Shenzhen (CN); Maocai LI, Shenzhen (CN); Nan JIANG, Shenzhen (CN)

(21) Appl. No.: 14/588,820

(22) Filed: Jan. 2, 2015

Related U.S. Application Data
(63) Continuation of application No. PCT/CN2014/083552, filed on Aug. 1, 2014.

(30) Foreign Application Priority Data
Dec. 30, 2013 (CN) 201310746471.2

(51) Int. Cl. G06Q 20/38; G06Q 20/40

(52) U.S. Cl. CPC G06Q 20/382; G06Q 20/40

(57) ABSTRACT

A method of authorizing a payment transaction is disclosed. The method includes: at a payment server, receiving, from a user device, a payment request and a payment key entered by a user at the user device. The method further includes, receiving, from the user device and with the payment key, predetermined device identification data for the user device; determining whether the predetermined device identification data corresponds to a registered user device associated with a payment account identified by the payment request; and in accordance with an outcome of the determining, selecting a corresponding reference payment key from multiple reference payment keys stored for the payment account, to verify the payment key entered by the user.

### PRIORITY CLAIM AND RELATED APPLICATIONS

This application is a continuation application of PCT Patent Application No. PCT/CN2014/083552, entitled “INFORMATION CONFIGURATION METHOD, DEVICE, SYSTEM, CLIENT AND SERVER” filed on Aug. 1, 2014, which claims priority to Chinese Patent Application No. 201310746471.2, “INFORMATION CONFIGURATION METHOD, DEVICE, SYSTEM, CLIENT AND SERVER,” filed on Dec. 30, 2013, both of which are hereby incorporated by reference in their entirety.

### FIELD OF THE TECHNOLOGY

The present technique relates to the field of Internet technologies, and in particular to an information configuration method, device, system, client and server.

### BACKGROUND

With the development of Internet technology, transaction payments performed over the Internet have become increasingly popular. At present, the transaction payment process based on Internet generally does not contain an information pre-configuration process, i.e., a user needs to manually enter information such as payment account information and user information to accomplish a payment flow in each transaction payment process, with a complex operation and low convenience. In addition, there is no information configuration process before the initiation of the transaction payment flow, and the user is unable to set a payment key regarding the transaction payment process, thus reducing the security and reliability of transaction payment.

### SUMMARY

Authorizing a payment transaction by entering a password or payment key on certain electronic devices (e.g., a mobile phone or tablet), can often be a laborious process involving switching between keyboards (e.g., numerical, symbols, letters keyboards, etc.) and deleting characters to get back to a typo. Using a very short password, on its own however, poses security risks to unauthorized access to the payment account.

The above deficiencies and other problems associated with authorizing a payment transaction are addressed by the techniques disclosed herein. In some embodiments, the method for authorizing a payment transaction is implemented on a computer system that has one or more processors, memory and one or more modules, programs or sets of instructions stored in the memory for performing multiple functions. Instructions for performing these functions may be included in a computer program product configured for execution by one or more processors.

In one aspect, a computer-implemented method of authorizing a payment transaction, at a payment server having one or more processors, and memory for storing programs to be executed by the one or more processors, includes receiving, from a user device, a payment request and a payment key entered by a user at the user device, receiving, from the user device and with the payment key, predetermined device identification data for the user device, determining whether the predetermined device identification data corresponds to a registered user device associated with a payment account identified by the payment request, and in accordance with an outcome of the determining, selecting a corresponding reference payment key from multiple reference payment keys stored for the payment account, to verify the payment key entered by the user.

In another aspect, a server for authorizing a payment transaction includes memory, one or more processors, and one or more programs stored in the memory and configured for execution by the one or more processors to perform the method described herein.

In another aspect, a non-transitory computer readable storage medium stores one or more programs, the one or more programs comprising instructions, which when executed by a server, cause the server to perform the method described herein.

Various advantages of the disclosed technology would be apparent in light of the descriptions below.

### BRIEF DESCRIPTION OF THE DRAWINGS

The aforementioned features and advantages of the disclosed embodiments as well as additional features and advantages thereof will be more clearly understood hereinafter as a result of a detailed description of preferred embodiments when taken in conjunction with the drawings.

The following briefly describes the accompanying drawings included for describing the embodiments or the prior art. The accompanying drawings in the following descriptions merely show some embodiments, and persons of ordinary skill in the art can derive other drawings from these accompanying drawings without creative efforts.

FIG. 1 is a flowchart of an information configuration method provided in some embodiments;

FIG. 2 is a flowchart of another information configuration method provided in some embodiments;

FIG. 3 is a flowchart of still another information configuration method provided in some embodiments;

FIG. 4 is a flowchart of still another information configuration method provided in some embodiments;

FIG. 5 is a flowchart of still another information configuration method provided in some embodiments;

FIGS. 6A-6B are a flow chart of a method of authorizing a payment transaction at a payment server in accordance with some embodiments.

FIG. 7A is a block diagram of an information configuration device provided in some embodiments;

FIG. 7B is a block diagram of another information configuration device provided in some embodiments;

FIG. 8 is a block diagram of a client provided in some embodiments;

FIG. 9 is a block diagram of still another information configuration device provided in some embodiments;

FIG. 10 is a block diagram of still another information configuration device provided in some embodiments;

FIG. 11a is a block diagram of an embodiment of an authentication module provided in some embodiments;

FIG. 11b is a block diagram of another embodiment of an authentication module provided in some embodiments;

FIG. 12 is a block diagram of an embodiment of a verification module provided in some embodiments;

FIG. 13 is a block diagram of an embodiment of a payment processing module provided in some embodiments;

FIG. 14 is a block diagram of a server provided in some embodiments;

FIG. 15 is a graphical representation of an information configuration device provided in some embodiments;

FIG. 16 is a block diagram of a client-server environment for authorizing a payment transaction in accordance with some embodiments;

FIG. 17 is a block diagram of an exemplary server for authorizing a payment transaction in accordance with some embodiments;

FIG. 18 is a block diagram of an apparatus of authorizing a payment transaction in accordance with some embodiments; and

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

The technical solutions in an embodiment of the present disclosure are hereinafter described clearly and completely with reference to the accompanying drawings. Evidently, the described embodiments are only some embodiments of the present technique, rather than all embodiments of the present technique. All other embodiments obtained by persons of ordinary skill in the art based on the embodiments of the present disclosure without creative efforts shall fall within the scope of protection of the present disclosure.

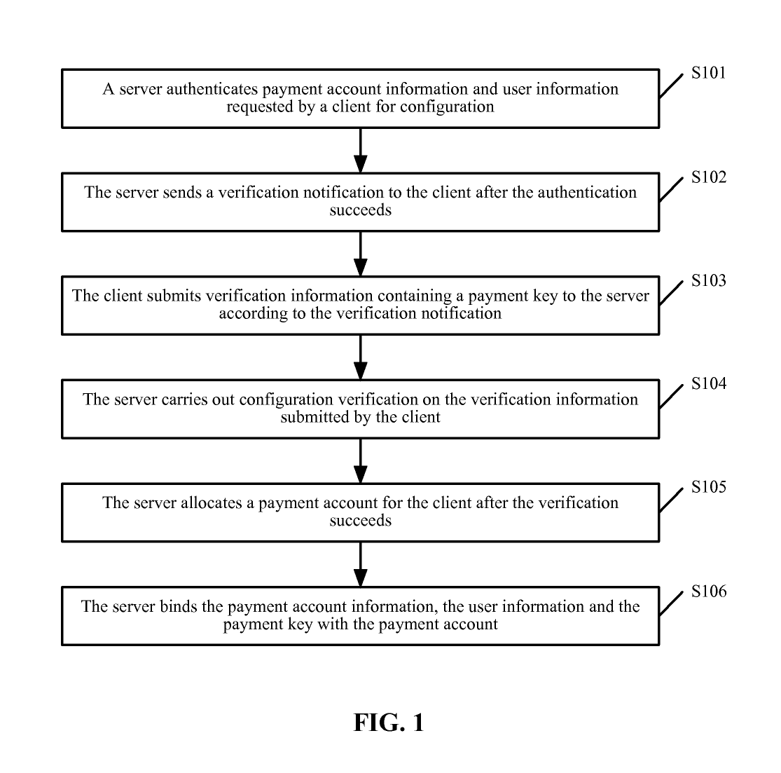

An information configuration method provided in an embodiment of the present technique is described in detail with reference to FIGS. 1-3. It should be noted that the information configuration method shown in FIGS. 1-3 may be executed through the interaction between a client and a server provided in an embodiment of the present technique, wherein the client may include, but not limited to, a PC (Personal Computer), a PAD (tablet PC), a mobile phone, a smart phone, a laptop PC and the like.

Please refer to FIG. 1, which is a flowchart of an information configuration method provided in an embodiment of the present technique. This embodiment describes a flow of the information configuration method from the aspect of the interaction between a client and a server. The method may comprise step S101 to step S106 as follows.

S101, a server authenticates payment account information and user information requested by a client for configuration.

The payment account information may refer to transaction account information issued by a third-party transaction system, comprising: bank card information or credit card information, wherein the bank card information may comprise: the card holder's name, the bank card number, the expiration date of the bank card, issue bank information and the like; the credit card information may comprise: the card holder's name, the credit card number, the expiration date of the credit card, issue bank information and the like; and the third-party transaction system may refer to a bank system.

The user information may comprise: user name information and/or user ID information, wherein the user ID information may refer to identification information for uniquely identifying a user, and may include, but not limited to, ID number information, email account information, phone number information and the like. This step may carry out identity authentication on the payment account information and user information, i.e., authenticating whether a user corresponding to the user information has payment rights of the payment account information.

S102, the server sends a verification notification to the client after the authentication succeeds.

In this step, after the identity authentication for the payment account information and user information succeeds, the server may send a verification notification to the client in a manner such as a short message, a multimedia message or an email, and the verification notification is used to notify the client to actively initiate configuration verification, e.g., the server may send a verification notification to the client in a manner of short message to notify the client to actively reply the verification information to initiate short message verification.

S103, the client submits verification information containing a payment key to the server according to the verification notification.

The payment key is a key for transaction payment set by a client-side user. Generally, a payment key may be constituted by letters, digits or special characters. In order to help the user to enter and use the payment key easily and without compromising security, in an embodiment of the present technique, the user can provide a compact payment key of preferably a six-digit string, i.e., the payment key is a key preferably constituted by six digits. During subsequent payment verification, the server can use the compact payment key in conjunction with other verification information (e.g., device identification information for the client device) to determine whether the payment key is submitted by the correct user using the correct user device. In order to allow the user to use other devices (i.e., devices not associated with the payment account or the compact keyword) for payment verification, the user can also choose to enter a regular full-length payment key which ensures security by including more types of characters and/or a longer key length. The user can register both types of keys for a payment account during the account setup process. The registration of the compact payment key is also accompanied by registration of one or more registered devices on which the compact payment key can be used. Corresponding to the sending manner in which the server issues a verification notification in step S102, in this step, the client may submit verification information containing a payment key to the server in a manner such as a short message, a multimedia message or an email to initiate configuration verification. The client device is configured to submit device identification information (e.g., a unique device ID, a unique manufacturer's serial number for the client device) with the device registration and the compact payment key registration during the account setup process and subsequent payment verification process using the compact payment key.

S104, the server carries out configuration verification on the verification information submitted by the client.

In this step, the configuration verification for verification information submitted by the client can effectively control the risks during information configuration to improve information security during information configuration.

S105, the server allocates a payment account for the client after the verification succeeds.

In this step, the process in which the server allocates a payment account for the client is actually a process in which the server creates a payment account for the client, wherein the payment account may refer to an account for the client to initiate a transaction payment flow, i.e., after the information configuration succeeds, the client may use the payment account to initiate a transaction payment flow to the server.

S106, the server binds the payment account with the payment account information, the user information and the payment key.

It should be noted that, after this step binds the payment account with the payment account information and user information and the payment key(s), the client may initiate a transaction payment flow based on the payment account without repeatedly entering the payment account information and user information, and also use the payment key(s) to carry out payment verification to ensure payment security, such that the transaction payment flow is simpler, safer and more convenient.

In an embodiment of the present technique, a server may authenticate the payment account information and user information requested by a client for configuration, carry out configuration verification on the verification information containing a payment key submitted by the client, and bind a payment account allocated for the client with the payment account information, the user information and the payment key; a series of processes, such as authentication and verification, may effectively ensure information security during information configuration; the binding processing may avoid the user carrying out information input repeatedly during the transaction payment process that is initiated after information configuration, thus simplifying the transaction payment flow and improving the transaction payment efficiency; and the payment key may be set by the client during information configuration, which improves the security and reliability of the transaction payment initiated after information configuration.

For example, once the server has bound the payment account with one or more registered devices, and for each registered device, the server has bound a respective compact payment key and corresponding device identification information, the server can use the device identification information in conjunction with the corresponding compact key to verify a payment key entered by the user at the time of a payment transaction. For example, at the time of a payment transaction, the server determines whether the client device submitting the payment key is a registered device based on a comparison of the device identification information received from the client device and stored device identification information for one or more registered devices for the payment account; and if the received device identification matches that of a registered device for the payment account, the server chooses a compact payment key stored for the registered device (or payment account) to verify the received payment key. If the server determines that the client device is not a registered device associated with the payment account, the server verifies the received payment key using a full-length key stored for the payment account, or rejects the payment key altogether. If the payment key is compared to a full-length key stored for the payment account, and the keys match, the server considers the verification a success. If the payment key is compared to the compact key stored for the registered device (or the compact key stored for the payment account, if a single compact key is stored for all registered device(s) associated with the payment account), the server considers the verification a success. With a verification success the payment transaction can proceed.

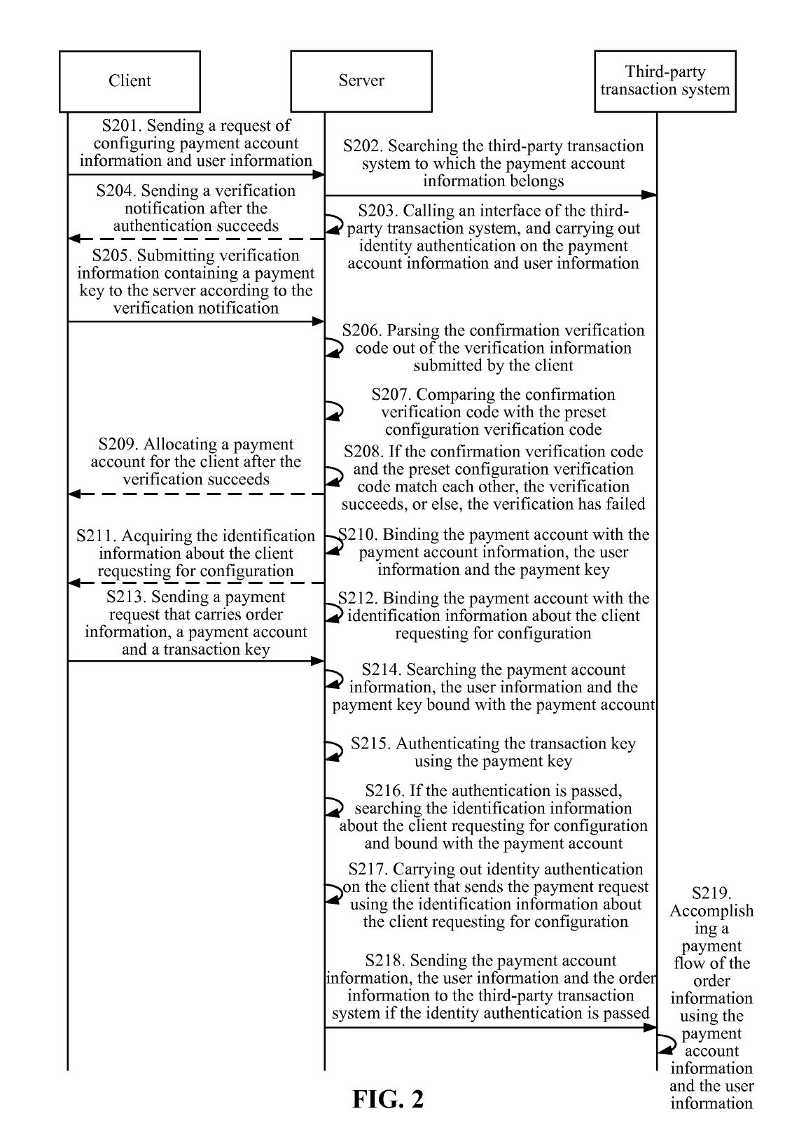

Please refer to FIG. 2, which is a flowchart of another information configuration method provided in an embodiment of the present technique. This embodiment describes a flow of the information configuration method from the aspect of the interaction between a client and a server. The method may comprise step S201 to step S219 as follows.

S201, a client sends to a server a request of configuring payment account information and user information.

The payment account information may refer to transaction account information issued by a third-party transaction system, comprising: bank card information or credit card information, wherein the bank card information may comprise: the card holder's name, the bank card number, the expiration date of the bank card, issue bank information and the like; the credit card information may comprise: the card holder's name, the credit card number, the expiration date of the credit card, issue bank information and the like; and the third-party transaction system may refer to a bank system.

The user information may comprise: user name information and/or user ID information, wherein the user ID information may refer to identification information for uniquely identifying a user, and may include, but not limited to, ID number information, email account information, phone number information and the like. In this step, the client may send to the server a request of configuring payment account information and user information in a manner such as a short message, a multimedia message or an email.

S202, the server searches a third-party transaction system to which the payment account information belongs.

In this step, the server searches for the payment account information is the transaction account information issued by which third-party transaction system, e.g., given that the payment account information is XX bank credit card information, the server may find that XX bank system is the third-party transaction system to which the payment account information belongs.

S203, the server calls an interface of the third-party transaction system, and carries out identity authentication on the payment account information and user information.

The third-party transaction system may provide an API interface, and the server calls the API interface provided by the third-party transaction system, so as to carry out identity authentication on the payment account information and user information, i.e., authenticating whether a user corresponding to the user information has payment rights of the payment account information; e.g., according to the example in step S202, the server may call an API interface of XX bank system, and authenticate whether the user corresponding to the user information is a card holder of the XX bank credit card, so as to determine whether the user corresponding to the user information has payment rights of the XX bank credit card.

Step S202 and step S203 in this embodiment may be specific detailed steps of step S101 of the embodiment shown in FIG. 1.

S204, the server sends a verification notification to the client after the authentication succeeds.

In this embodiment, the verification notification carries a preset configuration verification code which may be a verification code randomly generated by the server and which may be at least one of digits, letters, a graph and a formula, e.g., the preset configuration verification code may be “35LM”, alternatively, the preset configuration verification code may be “3+2=?”.

S205, the client submits verification information containing a payment key to the server according to the verification notification.

In this embodiment, the verification information carries a confirmation verification code therein. In this step, after receiving the verification notification issued by the server, the client outputs the preset configuration verification code carried in the verification notification, to remind the user to enter the confirmation verification code by reference to the preset configuration verification code; e.g., according to the example in step S204, the client displays that the preset configuration verification code is “35LM” to remind the user to enter “35LM” as the confirmation verification code; alternatively, the client displays that the preset configuration verification code is “3+2=?” to remind the user to enter “5” as the confirmation verification code. Furthermore, the user may set the payment key while entering the confirmation verification code, and the client may generate verification information containing a payment key according to the confirmation verification code entered by the user and the set payment key, and submit the verification information containing a payment key to the server.

S206, the server parses the confirmation verification code out of the verification information submitted by the client.

In this step, the server may parse and separate the verification information submitted by the client to obtain the confirmation verification code and the payment key.

S207, the server compares the confirmation verification code with the preset configuration verification code.

In this step, the server compares the confirmation verification code with the preset configuration verification code, comprising the following several cases:

in the first case: given that the preset configuration verification code is at least one of digits, letters and a graph, the server may compare whether the confirmation verification code is completely identical to the preset configuration verification code, e.g., if the preset configuration verification code is “35LM (capital) ” and the confirmation verification code is “35LM (capital)”, the server determines that they are completely identical by comparison to confirm that they match each other.

In the second case: given that the preset configuration verification code is at least one of digits, letters and a graph, the server may compare whether the confirmation verification code is substantially identical to the preset configuration verification code, e.g., if the preset configuration verification code is “35LM (capital)” and the confirmation verification code is “35lm (lowercase)”, the server determines that they are substantially identical by comparison to confirm that they match each other; alternatively, if the preset configuration verification code is a graph of “♦ (solid)” and the confirmation verification code is a graph of “⋄ (hollow)”, the server determines that they are substantially identical by comparison to confirm that they match each other.

In the third case: given that the preset configuration verification code is a formula, the server may compare whether the computation results of the confirmation verification code and the preset configuration verification code are the same, e.g., if the preset configuration verification code is “3+2=?” and the confirmation verification code is “5”, the server determines that the computation results of the confirmation verification code and the preset configuration verification code are the same by comparison to confirm that they match each other.

S208, if the confirmation verification code and the preset configuration verification code match each other, the server confirms that the verification succeeds, or else, confirms that the verification has failed.

Step S206 to step S208 in this embodiment may be specific detailed steps of step S104 of the embodiment shown in FIG. 1.

S209, the server allocates a payment account for the client after the verification succeeds.

S210, the server binds the payment account with the payment account information, the user information and the payment key. In some embodiments, the payment key is bound with the device from which the confirmation verification code is received, and the device is bound to the account and the payment key as a registered device.

Step S209 and step S210 in this embodiment may refer to step S105 and step S106 of the embodiment shown in FIG. 1, which is unnecessary to describe here in details.

S211, the server acquires the device identification information about the client requesting for configuration.

The device identification information about the client requesting for configuration is used to uniquely identify the client device requesting for configuration, the identification information being a delivery serial number, an MAC address and the like, e.g., if the client requesting for configuration is a mobile phone, the identification information about the client requesting for configuration is the delivery serial number of the mobile phone.

S212, the server binds the payment account with the identification information about the client requesting for configuration.

S213, the client sends to the server a payment request that carries order information, a payment account and a transaction key (e.g., a compact or full-length payment key).

When the user initiates payment transaction for the order information using the client device, the client sends to the server a payment request, wherein the payment request carries order information, a payment account and a transaction key. Generally, the transaction key may be constituted by letters, digits or special characters. In this embodiment, the transaction key is a compact key (e.g., preferably a six-digit key). Since the server has bound the payment account with the payment account information, the user information and the compact payment key during an earlier information configuration process (e.g., an account set-up process), the user need not re-enter the payment account information and the user information during the payment request process in this step, thus effectively simplifying the transaction payment flow.

S214, the server searches the payment account information, the user information and the payment key bound with the payment account.

S215, the server authenticates the entered transaction key using an appropriate payment key associated with the payment account.

In this step, the server judges whether the stored payment key is identical to the received transaction key, and if the stored payment key is identical to the received transaction key, the authentication is passed; or else, the authentication has failed. This step carries out payment verification on the currently received transaction key in this transaction payment flow using a payment key that is pre-bound by the user, which can effectively ensure security during this transaction payment process.

S216, if the authentication is passed, the server searches the identification information about the client that requests for configuration and is bound with the payment account.

S217, the server carries out identity authentication on the client that sends the payment request using the identification information about the client requesting for configuration.

In this embodiment, step S211 to step S212 and step S216 to step S217 are optional steps; i.e., in this embodiment, after step S210 is executed, go to step S213 directly; and after step S215 is executed and the authentication is passed, go to step S218 directly. The optional steps are set in this embodiment in order to carry out identity authentication on the client to further improve the security of the transaction payment flow.

S218, if the identity authentication is passed, the server sends the payment account information, the user information and the order information to the third-party transaction system.

S219, the third-party transaction system accomplishes the payment flow of the order information using the payment account information and the user information.

In this step, the third-party transaction system may carry out operations, such as balance query and payment deduction, for the payment account information according to the order information, so as to accomplish the payment flow of the order information.

In an embodiment of the present technique, a server may authenticate the payment account information and user information requested by a client for configuration, carry out configuration verification on the verification information containing a payment key submitted by the client, and bind a payment account allocated for the client with the payment account information, the user information and the payment key; a series of processes, such as authentication and verification, may effectively ensure information security during information configuration; the binding processing may avoid the user carrying out information input repeatedly during the transaction payment process that is initiated after information configuration, thus simplifying the transaction payment flow and improving the transaction payment efficiency; and the payment key may be set by the client during information configuration, which improves the security and reliability of the transaction payment initiated after information configuration.

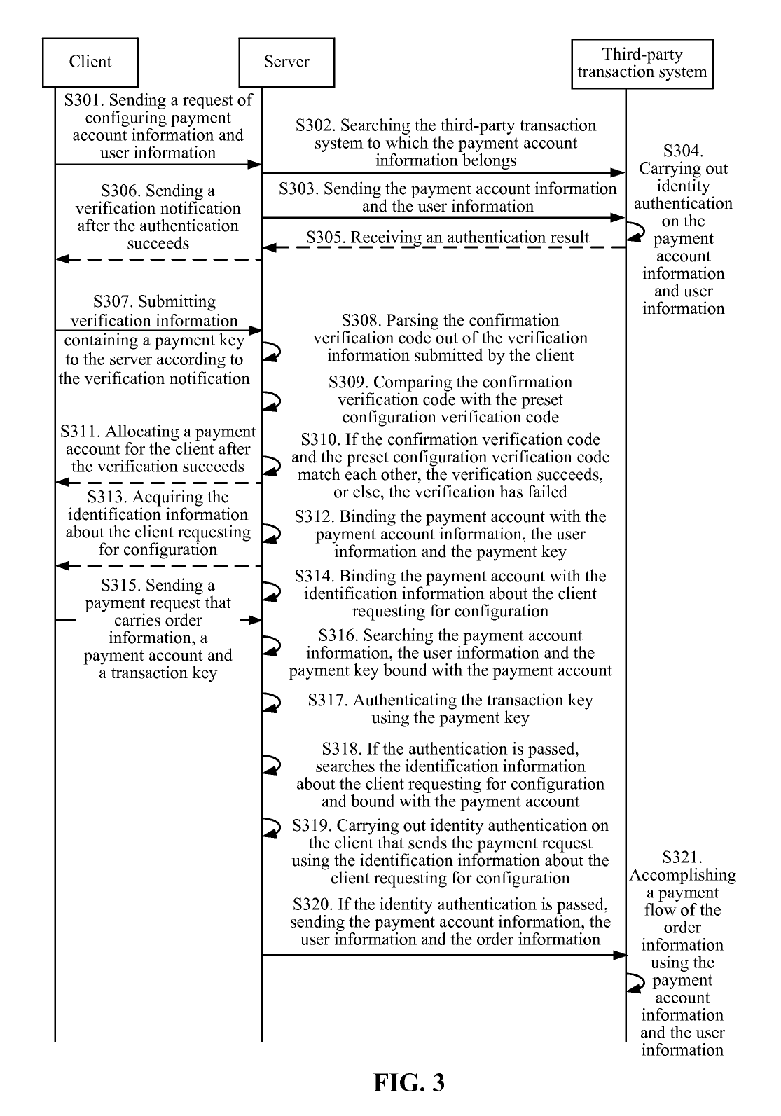

Please refer to FIG. 3, which is a flowchart of still another information configuration method provided in an embodiment of the present technique. This embodiment describes a flow of the information configuration method from the aspect of the interaction between a client and a server. The method may comprise step S301 to step S321 as follows.

S301, a client sends to a server a request of configuring payment account information and user information.

Step S301 in this embodiment may refer to step S201 of the embodiment shown in FIG. 2, which is unnecessary to describe here in details.

S302, the server searches the third-party transaction system to which the payment account information belongs.

In this step, the server searches for the payment account information is the transaction account information issued by which third-party transaction system, e.g., given that the payment account information is XX bank credit card information, the server may find that XX bank system is the third-party transaction system to which the payment account information belongs.

S303, the server sends the payment account information and the user information to the third-party transaction system.

S304, the third-party transaction system carries out identity authentication on the payment account information and user information.

According to the example in step S302, in this step, the third-party transaction system may authenticate whether the user corresponding to the user information is a card holder of the XX bank credit card, so as to determine whether the user corresponding to the user information has payment rights of the XX bank credit card.

S305, the server receives the authentication result returned from the third-party transaction system.

The authentication result comprises successful authentication or failed authentication. It should be noted that step S302 to step S305 of this embodiment may be specific detailed steps of step S101 of the embodiment shown in FIG. 1.

S306, the server sends a verification notification to the client after the authentication succeeds.

S307, the client submits verification information containing a payment key to the server according to the verification notification.

S308, the server parses the confirmation verification code out of the verification information submitted by the client.

S309, the server compares the confirmation verification code with the preset configuration verification code.

S310, if the confirmation verification code and the preset configuration verification code match each other, the server confirms that the verification succeeds, or else, confirms that the verification has failed.

S311, the server allocates a payment account for the client after the verification succeeds.

S312, the server binds the payment account with the payment account information, the user information and the payment key.

S313, the server acquires the identification information about the client requesting for configuration.

S314, the server binds the payment account with the identification information about the client requesting for configuration. In some embodiments, the server binds the payment key (e.g., the compact payment key) with the client device that submits the confirmation verification code.

S315, the client sends to the server a payment request, wherein the payment request carries order information, a payment account and a payment key.

S316, the server searches the payment account information, the user information and the payment key bound with the payment account.

S317, the server authenticates the transaction key using the payment key.

S318, if the authentication is passed, the server searches the identification information about the client that requests for configuration and is bound with the payment account.

S319, the server carries out identity authentication on the client that sends the payment request using the identification information about the client requesting for configuration.

S320, if the identity authentication is passed, the server sends the payment account information, the user information and the order information to the third-party transaction system.

S321, the third-party transaction system accomplishes the payment flow of the order information using the payment account information and the user information.

Step S306 to step S321 in this embodiment may refer to step S204 to step S219 of the embodiment shown in FIG. 2, which is unnecessary to describe here in details.

In an embodiment of the present technique, a server may authenticate the payment account information and user information requested by a client for configuration, carry out configuration verification on the verification information containing a payment key submitted by the client, and bind a payment account allocated for the client with the payment account information, the user information and the payment key; a series of processes, such as authentication and verification, may effectively ensure information security during information configuration; the binding processing may avoid the user carrying out information input repeatedly during the transaction payment process that is initiated after information configuration, thus simplifying the transaction payment flow and improving the transaction payment efficiency; and the payment key may be set by the client during information configuration, which improves the security and reliability of the transaction payment initiated after information configuration.

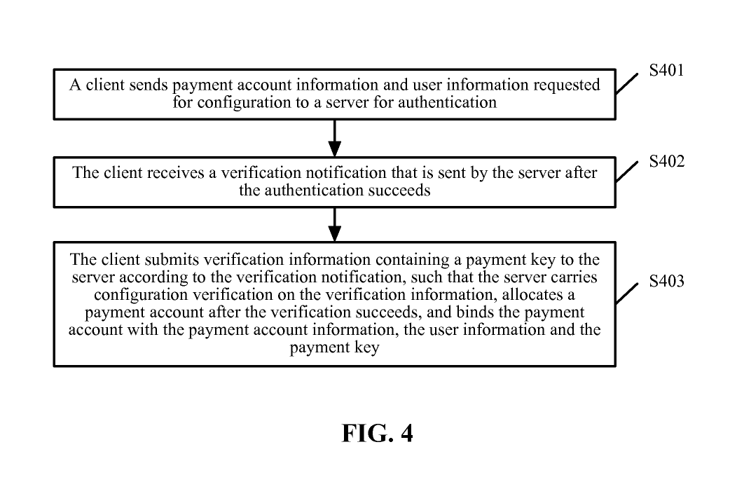

An information configuration method provided in an embodiment of the present technique is described in detail with reference to FIG. 4. It should be noted that the information configuration method shown in FIG. 4 may be executed by a client provided in an embodiment of the present technique, wherein the client may include, but not limited to, a PC, a PAD, a mobile phone, a smart phone, a laptop PC and the like.

Please refer to FIG. 4, which is a flowchart of still another information configuration method provided in an embodiment of the present technique. This embodiment describes a flow of the information configuration method from the aspect of a client. The method may comprise step S401 to step S403 as follows.

S401, a client sends payment account information and user information requested for configuration to a server for authentication.

The payment account information may refer to transaction account information issued by a third-party transaction system, comprising: bank card information or credit card information, wherein the bank card information may comprise: the card holder's name, the bank card number, the expiration date of the bank card, issue bank information and the like; the credit card information may comprise: the card holder's name, the credit card number, the expiration date of the credit card, issue bank information and the like; and the third-party transaction system may refer to a bank system.

The user information may comprise: user name information and/or user ID information, wherein the user ID information may refer to identification information for uniquely identifying a user, and may include, but not limited to, ID number information, email account information, phone number information and the like. In this step, the client may send to the server a request of configuring payment account information and user information in a manner such as a short message, a multimedia message or an email, and the server authenticates the payment account information and user information.

S402, the client receives a verification notification that is sent by the server after the authentication succeeds.

In this step, after the identity authentication for the payment account information and user information by the server succeeds, the client may receive, in a manner of short message, multimedia message or email, a verification notification that is sent by the server and used to notify the client to actively initiate configuration verification.

S403, the client submits verification information containing a payment key to the server according to the verification notification, such that the server carries configuration verification on the verification information, allocates a payment account after the verification succeeds, and binds the payment account with the payment account information, the user information and the payment key.

The payment key is a key for payment transaction set by a client-side user; and generally, the payment key may be constituted by letters, digits or special characters. In order to help the user to enter and use the payment key, in an embodiment of the present technique, the payment key is a six-digit key, i.e., the payment key is a password comprising six digits. In this step, the client may submit verification information containing a payment key to the server in a manner such as a short message, a multimedia message or an email to initiate configuration verification. The payment account may refer to an account through which the client initiates a transaction payment flow, i.e., after the information configuration succeeds, the client may initiate a transaction payment flow to the server using the payment account. After the server binds the payment account with the payment account information and user information and the payment key, the client may initiate a transaction payment flow based on the payment account without repeatedly entering the payment account information and user information, and also use the payment key to carry out payment verification to ensure payment security, such that the transaction payment flow is simpler, safer and more convenient.

In an embodiment of the present technique, a server may authenticate the payment account information and user information requested by a client for configuration, carry out configuration verification on the verification information containing a payment key submitted by the client, and bind a payment account allocated for the client with the payment account information, the user information and the payment key; a series of processes, such as authentication and verification, may effectively ensure information security during information configuration; the binding processing may avoid the user carrying out information input repeatedly during the transaction payment process that is initiated after information configuration, thus simplifying the transaction payment flow and improving the transaction payment efficiency; and the payment key may be set by the client during information configuration, which improves the security and reliability of the transaction payment initiated after information configuration.

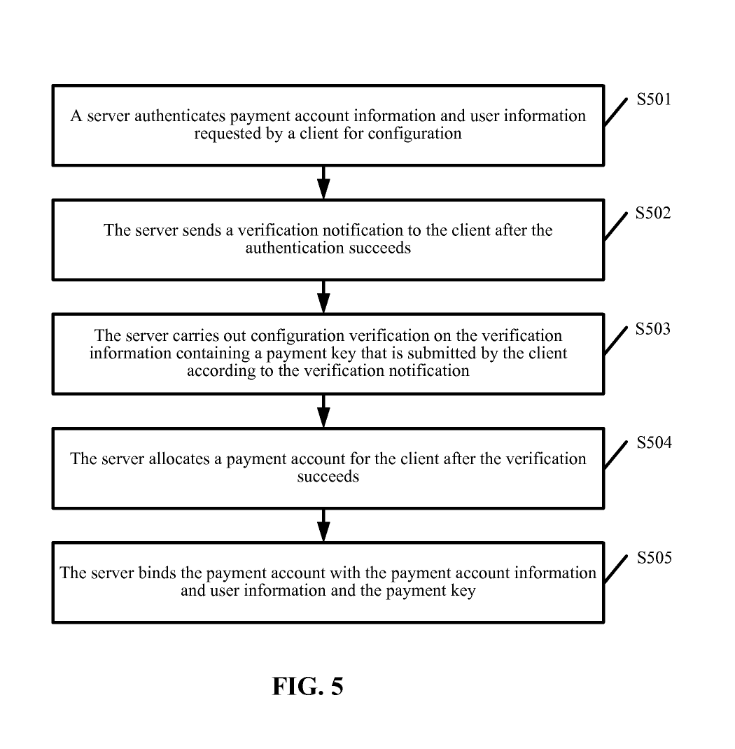

An information configuration method provided in an embodiment of the present technique is described in detail with reference to FIG. 5. It should be noted that the information configuration method shown in FIG. 5 may be executed by a server provided in an embodiment of the present technique.

Please refer to FIG. 5, which is a flowchart of still another information configuration method provided in an embodiment of the present disclosure. This embodiment describes a flow of the information configuration method from the aspect of a server. The method may comprise step S501 to step S505 as follows.

S501, a server authenticates the payment account information and user information requested by a client for configuration.

The payment account information may refer to transaction account information issued by a third-party transaction system, comprising: bank card information or credit card information, wherein the bank card information may comprise: the card holder's name, the bank card number, the expiration date of the bank card, issue bank information and the like; the credit card information may comprise: the card holder's name, the credit card number, the expiration date of the credit card, issue bank information and the like; and the third-party transaction system may refer to a bank system.

The user information may comprise: user name information and/or user ID information, wherein the user ID information may refer to identification information for uniquely identifying a user, and may include, but not limited to, ID number information, email account information, phone number information and the like. This step may carry out identity authentication on the payment account information and user information, i.e., authenticating whether a user corresponding to the user information has payment rights of the payment account information.

S502, the server sends a verification notification to the client after the authentication succeeds.

In this step, after the identity authentication for the payment account information and user information succeeds, the server may send a verification notification to the client in a manner such as a short message, a multimedia message or an email, and the verification notification is used to notify the client to actively initiate configuration verification, e.g., the server may send a verification notification to the client in a manner of short message to notify the client to actively reply the verification information to initiate short message verification.

S503, the server carries out configuration verification on the verification information containing a payment key that is submitted by the client according to the verification notification.

In this step, the configuration verification for verification information submitted by the client can effectively control the risks during information configuration to improve information security during information configuration.

S504, the server allocates a payment account for the client after the verification succeeds.

In this step, the process whereby the server allocates a payment account for the client is actually a process whereby the server creates a payment account for the client, wherein the payment account may refer to an account for the client to initiate a transaction payment flow, i.e., after the information configuration succeeds, the client may use the payment account to initiate a transaction payment flow to the server.

S505, the server binds the payment account with the payment account information and user information and the payment key.

It should be noted that, after this step binds the payment account with the payment account information and user information and the payment key, the client may initiate a transaction payment flow based on the payment account without repeatedly entering the payment account information and user information, and also use the payment key to carry out payment verification to ensure payment security, such that the transaction payment flow is simpler, safer and more convenient.

In an embodiment of the present technique, a server may authenticate the payment account information and user information requested by a client for configuration, carry out configuration verification on the verification information containing a payment key submitted by the client, and bind a payment account allocated for the client with the payment account information, the user information and the payment key; a series of processes, such as authentication and verification, may effectively ensure information security during information configuration; the binding processing may avoid the user carrying out information input repeatedly during the transaction payment process that is initiated after information configuration, thus simplifying the transaction payment flow and improving the transaction payment efficiency; and the payment key may be set by the client during information configuration, which improves the security and reliability of the transaction payment initiated after information configuration.

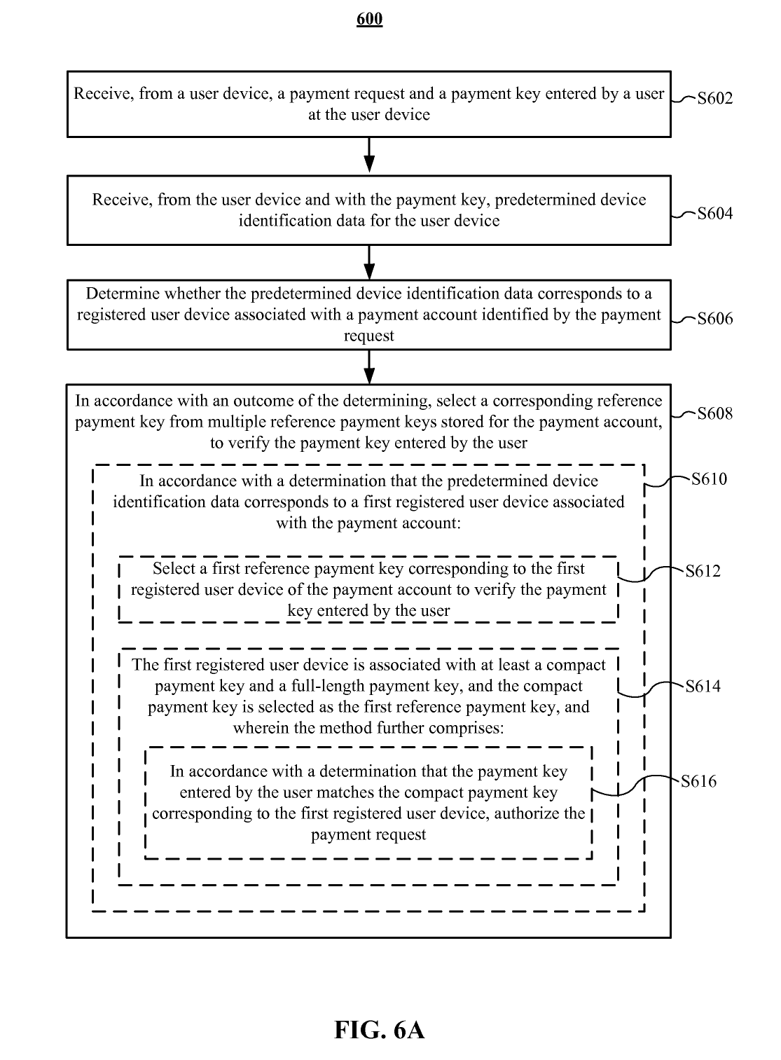

FIGS. 6A-6B are a flow chart of a method 600 of authorizing a payment transaction, at a payment server in accordance with some implementations of the present application. At a payment server having one or more processors, and memory for storing programs to be executed by the one or more processors, the method 600 includes receiving (S602), from a user device, a payment request and a payment key entered by a user at the user device. For example, a payment request comprises information such as transaction information related to a purchase, a payment account user name, and financial institution information. In some embodiments, the payment request comprises the payment key, and the payment key is a PIN, a password, a code or another form of security information used to authorize the payment request. In some embodiments the payment request is received as an email message, SMS, MMS or electronically submitted through an application running on the user device. The payment key entered during the payment transaction stage is also referred to as a transaction key in the present disclosure.

The method includes, receiving (S604), from the user device and with the payment key, predetermined device identification data for the user device. For example, the predetermined device identification data is a hardware-specific number associated with the client device such as a serial number, IMEI, MEID, SIM card number, or a software-specific identification such as a firmware version or operating system version. The method further includes determining (S606) whether the predetermined device identification data corresponds to a registered user device associated with a payment account identified by the payment request. For example, determining if the SIM card number corresponds to a mobile device associated with user Bob Jones' payment account.

The method further includes, in accordance with an outcome of the determining, selecting (S608) a corresponding reference payment key from multiple reference payment keys stored for the payment account, to verify the payment key entered by the user. For example, in accordance with a determination that the received SIM card number corresponds to Bob Jones' mobile device, selecting a first payment key (e.g., a 6-digit compact payment key). Reference keys are payment keys that were submitted and bound to the payment account during the account set-up stage for the payment account. The user can bound multiple keys to the payment account, for example, a full-length payment key for use with any device, and one or more compact payment keys each for use with a respective set of one or more registered devices.

In some embodiments, selecting the corresponding reference payment key from the multiple reference payment keys stored for the payment account in accordance with the outcome of the determining further comprises, in accordance with a determination that the predetermined device identification data corresponds (S610) to a first registered user device associated with the payment account, selecting (S612) the a first reference payment key corresponding to the first registered user device of the payment account to verify the payment key entered by the user.

In some embodiments, the first registered user device is associated (S614) with at least a compact payment key and a full-length payment key, the compact payment key is selected as the first reference payment key, and the method further comprises, in accordance with a determination that the payment key entered by the user matches the compact payment key corresponding to the first registered user device, authorizing (S616) the payment request. For example, the first registered user device is a mobile phone, and is associated with Bob Jones' payment account, a compact payment key (e.g., 123456) and a full-length payment key (e.g., 123456abcDEF).

In some embodiments, the method further comprises, in accordance with a determination that the payment key entered by the user does not match the compact payment key corresponding to the first registered user device, comparing the payment key entered by the user to the full-length payment key corresponding to the payment account. In these embodiments, the method further comprises, in accordance with a determination that the payment keyword entered by the user matches the full-length payment key, authorizing the payment request. For example, Bob Jones used his registered mobile phone to make a payment, but rather than using the convenient, compact payment key/password associated with his payment account, he used the full-length payment key.

In some embodiments, the compact payment key is a substring of the full-length payment key. For example, the compact payment key is “123456” and the full-length payment key is “123456abcDEF.”

In some embodiments, the first registered user device is associated with a full-length payment key and the method further comprises, in accordance with the determination that the predetermined device identification data corresponds to the first registered user device associated with the payment account, comparing the payment key entered by the user against a predetermined substring of the full-length payment key. For example, Bob Jones used his mobile phone to make a payment through his payment account having 123456abcDEF as the full-length key, but only entered 1234 or 456abc or another substring of the full-length password. In these embodiments, the method further includes, in accordance with a determination that the payment key entered by the user matches the predetermined substring of the full-length payment key, authorizing the payment request. In some embodiments, any substring of the full-length payment key can be entered by the user to authorize the payment request, and in some embodiments, the predetermined substring is a specific portion of the full-length payment key (e.g., first six characters, first six digits, all digits in the full-length password, every other character in the full-length password, etc.).

In some embodiments, the multiple reference payment keys include at least a full-length payment key associated with the payment account, and one or more compact payment keys associated with one or more registered user devices of the payment account. In some embodiments, selecting the corresponding reference payment key from the multiple reference payment keys stored for the payment account in accordance with the outcome of the determining further comprises, in accordance with a determination that the predetermined device identification data does not correspond to any of the one or more registered devices associated with the payment account, selecting the full-length payment key associated with the payment account to verify the payment key entered by the user. For example, Bob Jones is using his friend's computer (an unregistered device under his account) to make a purchase using his payment account, therefore he must use the full-length payment key associated with his payment account to make the purchase. In some embodiments, a payment request does not comprise predetermined device identification information (e.g., a payment request from a personal computer, or faulty transmission of device ID from a registered device), and the method then also includes selecting the full-length payment key associated with the payment account to verify the payment key entered by the user.

In some embodiments, the method further comprises, prior (S618) to receiving the payment request (e.g., during the account set-up stage for the payment account), receiving (S620) from the user device, a first password binding request for the payment account, wherein the first password binding request comprises the predetermined device identification data corresponding to the user device, and a compact payment key, in response to the first password binding request, associating (S622) the compact payment key and the predetermined device identification data with the payment account, receiving (S624) a second password binding request, wherein the second password binding request comprises a full-length payment key for the payment account, and wherein the full-length payment key has a higher security strength than the compact payment key, and in response to the second password binding request, associating (S626) the full-length payment key with the payment account. For example, Bob Jones decided to register for the compact password feature associated with his payment account, when creating his payment account for the first time. He sent a first password binding request comprising a first, compact password/payment key that he intends to use from his mobile device to make authorizing payments easy yet secure. The first password binding request also comprises the IMEI number of his mobile device, and is associated with his payment account and the first payment key. He also sends a second password binding request (before, after or at the same time as the first password binding request), to associate a second, potentially longer or more complex payment key with his payment account.

Other details of the above method are provided with reference to FIGS. 1-5 above and are not repeated here.

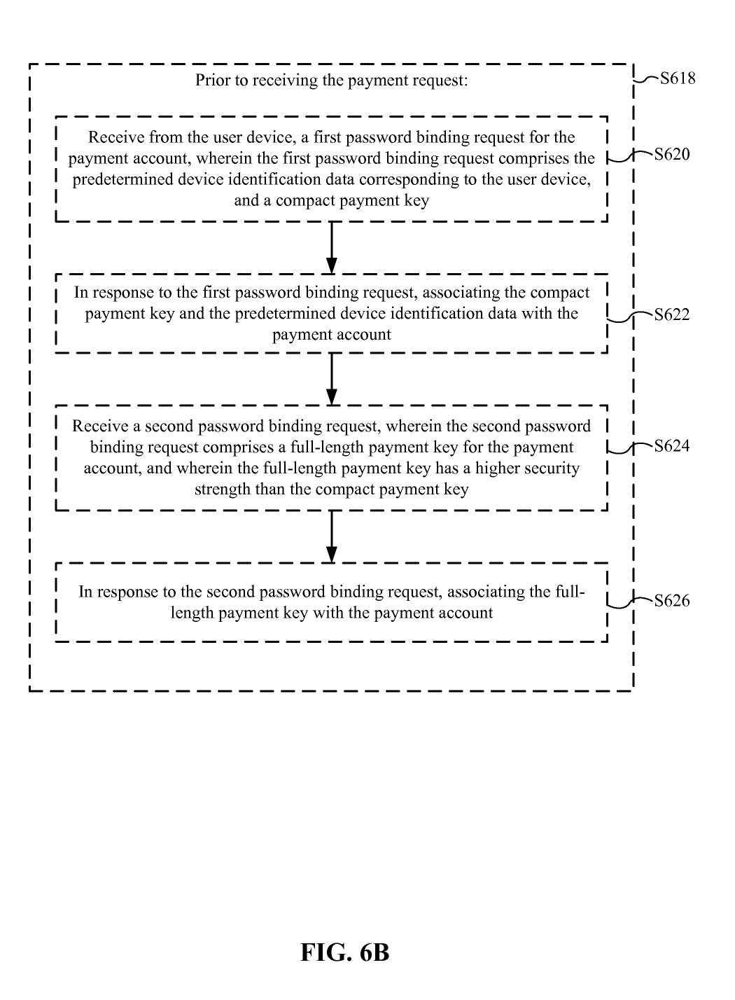

An information configuration device provided in an embodiment of the present technique is described in detail with reference to FIG. 7A and FIG. 7B. It should be noted that the information configuration device shown in FIG. 7A and FIG. 7B may be arranged in a client provided in an embodiment of the present technique, wherein the client may include, but not limited to, a PC, a PAD, a mobile phone, a smart phone, a laptop PC and the like.

Please refer to FIG. 7A, which is a block diagram of an information configuration device provided in an embodiment of the present technique. The device may comprise an authentication request module 101, a notification receiving module 102 and an information configuration module 103.

The authentication request module 101 is used to send payment account information and user information requested for configuration to a server for authentication.

The payment account information may refer to transaction account information issued by a third-party transaction system, comprising: bank card information or credit card information, wherein the bank card information may comprise: the card holder's name, the bank card number, the expiration date of the bank card, issue bank information and the like; the credit card information may comprise: the card holder's name, the credit card number, the expiration date of the credit card, issue bank information and the like; and the third-party transaction system may refer to a bank system.

The user information may comprise: user name information and/or user ID information, wherein the user ID information may refer to identification information for uniquely identifying a user, and may include, but not limited to, ID number information, email account information, phone number information and the like. The authentication request module 101 may send to the server a request of configuring payment account information and user information in a manner such as a short message, a multimedia message or an email, and the server authenticates the payment account information and user information.

The notification receiving module 102 is used to receive a verification notification sent by the server after the authentication succeeds.

After the identity authentication for the payment account information and user information by the server succeeds, the notification receiving module 102 may receive, in a manner of short message, multimedia message or email, the verification notification that is sent by the server and used to notify the client to actively initiate configuration verification.

The information configuration module 103 is used to submit verification information containing a payment key to the server according to the verification notification, such that the server carries out configuration verification on the verification information, allocate a payment account after the verification succeeds, and bind the payment account with the payment account information, the user information and the payment key.

The payment key is a key for transaction payment set by a client-side user; and generally, the payment key may be constituted by letters, digits or special characters. In order to help the user to enter and use the payment key, in an embodiment of the present technique, the payment key is preferably a six-digit key, i.e., the payment key is preferably a key constituted by six digits. The information configuration module 103 may submit verification information containing a payment key to the server in a manner such as a short message, a multimedia message or an email to initiate configuration verification. The payment account may refer to an account through which the client initiates a transaction payment flow, i.e., after the information configuration succeeds, the client may initiate a transaction payment flow to the server using the payment account. After the server binds the payment account with the payment account information and user information and the payment key, the client may initiate a transaction payment flow based on the payment account without repeatedly entering the payment account information and user information, and also use the payment key to carry out payment verification to ensure payment security, such that the transaction payment flow is simpler, safer and more convenient.

In an embodiment of the present technique, a server may authenticate the payment account information and user information requested by a client for configuration, carry out configuration verification on the verification information containing a payment key submitted by the client, and bind a payment account allocated for the client with the payment account information, the user information and the payment key; a series of processes, such as authentication and verification, may effectively ensure information security during information configuration; the binding processing may avoid the user carrying out information input repeatedly during the transaction payment process that is initiated after information configuration, thus simplifying the transaction payment flow and improving the transaction payment efficiency; and the payment key may be set by the client during information configuration, which improves the security and reliability of the transaction payment initiated after information configuration.

Please refer to FIG. 7B, which is a block diagram of another information configuration device provided in an embodiment of the present technique. The device may comprise an authentication request module 101, a notification receiving module 102, an information configuration module 103 and a payment request module 104. The structures and functions of the authentication request module 101, the notification receiving module 102 and the information configuration module 103 may refer to the relevant description of the embodiment shown in FIG. 7A, which is unnecessary to describe here in details.

The payment request module 104 is used to send to the server a payment request that carries order information, a payment account and a transaction key, such that the server may carries out payment processing on the order information in response to the payment request.

When a user initiates transaction payment for the order information using the client, the payment request module 104 sends to the server a payment request, wherein the payment request carries order information, a payment account and a transaction key. Generally, the transaction key may be constituted by letters, digits or special characters. In this embodiment, the transaction key is preferably a six-digit key. Since the server binds the payment account with the payment account information, the user information and the payment key during configuring information, the user need not re-enter the payment account information and the user information during the payment request process, thus effectively simplifying the transaction payment process.

In an embodiment of the present technique, a server may authenticate the payment account information and user information requested by a client for configuration, carry out configuration verification on the verification information containing a payment key submitted by the client, and bind a payment account allocated for the client with the payment account information, the user information and the payment key; a series of processes, such as authentication and verification, may effectively ensure information security during information configuration; the binding processing may avoid the user carrying out information input repeatedly during the transaction payment process that is initiated after information configuration, thus simplifying the transaction payment flow and improving the transaction payment efficiency; and the payment key may be set by the client during information configuration, which improves the security and reliability of the transaction payment initiated after information configuration.

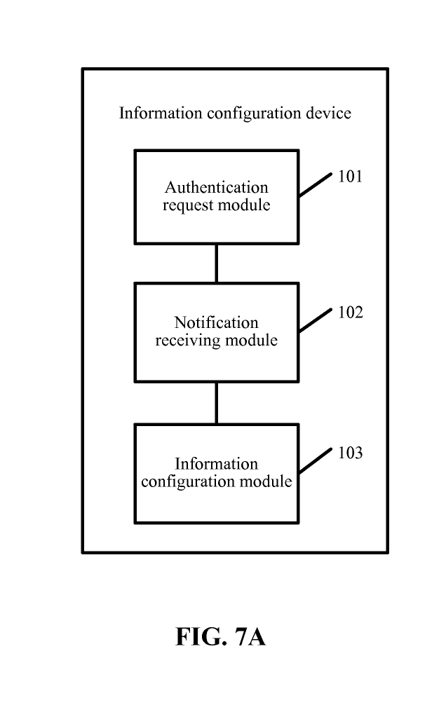

Please refer to FIG. 8, which is a block diagram of a client provided in an embodiment of the present technique. The client of the embodiment of the present technique comprises at least one processor 1001, e.g., a CPU, at least one communication bus 1002, at least one network interface 1003, and a memory 1004. The communication bus 1002 is used to implement connections and communications among these elements. Optionally, the network interface 1003 may comprise standard wired interfaces and wireless interfaces (such as WI-FI and mobile communication interface). The memory 1004 may be a high speed random access memory, or may be a non-volatile memory, e.g., at least one magnetic disk memory. Optionally, the memory 1004 may also be at least one memory device located away from the above-mentioned processor 1004. As shown in FIG. 8, the memory 1004 for being used as a computer storage medium stores operating systems and network communication modules therein, and also stores information configuration programs and other programs therein.

Specifically, the processor 1001 may be used to call the information configuration program stored in the memory 1004, and executes the following steps:

Sending payment account information and user information requested for configuration to a server for authentication;

After the authentication succeeds, receiving a verification notification that is sent by the server; and

Submitting verification information containing a payment key to the server according to the verification notification, such that the server carries out configuration verification on the verification information, allocates a payment account after the verification succeeds, and binds the payment account to the payment account information, the user information and the payment key.

The processor may also perform other functions of a client device described with respect to FIGS. 1-6B.

In an embodiment of the present technique, a server may authenticate the payment account information and user information requested by a client for configuration, carry out configuration verification on the verification information containing a payment key submitted by the client, and bind a payment account allocated for the client with the payment account information, the user information and the payment key; a series of processes, such as authentication and verification, may effectively ensure information security during information configuration; the binding processing may avoid the user carrying out information input repeatedly during the transaction payment process that is initiated after information configuration, thus simplifying the transaction payment flow and improving the transaction payment efficiency; and the payment key may be set by the client during information configuration, which improves the security and reliability of the transaction payment initiated after information configuration.

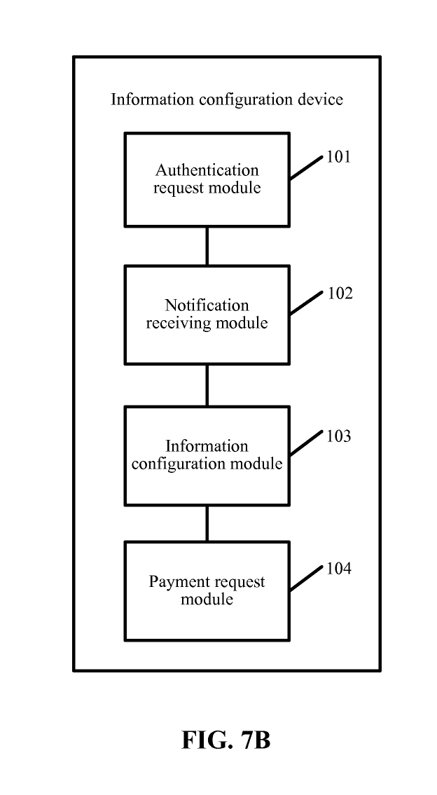

An information configuration device provided in an embodiment of the present technique is described in detail with reference to FIGS. 9-13. It should be noted that the information configuration device shown in FIGS. 9-13 may be arranged in a server provided in an embodiment of the present technique.

Please refer to FIG. 9, which is a block diagram of still another information configuration device provided in an embodiment of the present technique. The device may comprise an authentication module 201, a notification module 202, a verification module 203, an allocation module 204 and a configuration module 205.

The authentication module 201 is used to authenticate payment account information and user information requested by a client for configuration.

The payment account information may refer to transaction account information issued by a third-party transaction system, comprising: bank card information or credit card information, wherein the bank card information may comprise: the card holder's name, the bank card number, the expiration date of the bank card, issue bank information and the like; the credit card information may comprise: the card holder's name, the credit card number, the expiration date of the credit card, issue bank information and the like; and the third-party transaction system may refer to a bank system.

The user information may comprise: user name information and/or user ID information, wherein the user ID information may refer to identification information for uniquely identifying a user, and may include, but not limited to, ID number information, email account information, phone number information and the like. The authentication module 201 may carry out identity authentication on the payment account information and user information, i.e., authenticating whether a user corresponding to the user information has payment rights of the payment account information.

The notification module 202 is used to send a verification notification to the client after the authentication succeeds.

After the identity authentication for the payment account information and user information succeeds, the notification module 202 may send a verification notification to the client in a manner such as a short message, a multimedia message or an email, and the verification notification is used to notify the client to actively initiate configuration verification, e.g., the notification module 202 may send a verification notification to the client in a manner of short message to notify the client to actively reply the verification information to initiate short message verification.

The verification module 203 is used to carry out configuration verification on the verification information containing a payment key that is submitted by the client according to the verification notification.

The verification module 203 carries out configuration verification on the verification information submitted by the client, which can effectively control the risks during information configuration to improve information security during information configuration.

The allocation module 204 is used to allocate a payment account for the client after the verification succeeds.

The process whereby the allocation module 204 allocates a payment account for the client is actually a process whereby the allocation module 204 creates a payment account for the client, wherein the payment account may refer to an account for the client to initiate a transaction payment flow, i.e., after the information configuration succeeds, the client may use the payment account to initiate a transaction payment flow to the allocation module 204.

The configuration module 205 is used to bind the payment account with the payment account information and user information and the payment key.

It should be noted that, after the configuration module 205 binds the payment account with the payment account information and user information and the payment key, the client may initiate a transaction payment flow based on the payment account without repeatedly entering the payment account information and user information, and also use the payment key to carry out payment verification to ensure payment security, such that the transaction payment flow is simpler, safer and more convenient.

In some embodiments, a server may authenticate the payment account information and user information requested by a client for configuration, carry out configuration verification on the verification information containing a payment key submitted by the client, and bind a payment account allocated for the client with the payment account information, the user information and the payment key; a series of processes, such as authentication and verification, may effectively ensure information security during information configuration; the binding processing may avoid the user carrying out information input repeatedly during the transaction payment process that is initiated after information configuration, thus simplifying the transaction payment flow and improving the transaction payment efficiency; and the payment key may be set by the client during information configuration, which improves the security and reliability of the transaction payment initiated after information configuration.

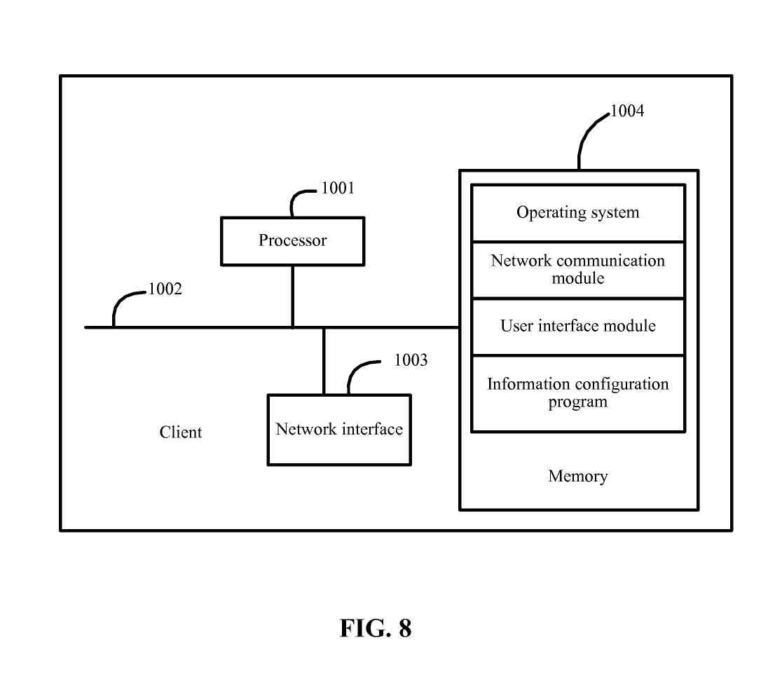

Please refer to FIG. 10, which is a block diagram of still another information configuration device provided in some embodiments. The device may comprise an authentication module 201, a notification module 202, a verification module 203, an allocation module 204, a configuration module 205, a payment processing module 206, an identification configuration module 207 and an identity authentication module 208.

The payment processing module 206 is used to carry out payment processing on the requested order information in response to a payment request of the client, the payment request carrying order information, a payment account and a transaction key therein.

The identification configuration module 207 is used to acquire the identification information about the client requesting for configuration, and bind the payment account with the identification information about the client requesting for configuration.

The identification information about the client requesting for configuration is used to uniquely identify the client requesting for configuration, the identification information being a delivery serial number, an MAC address and the like, e.g., if the client requesting for configuration is a mobile phone, the identification information about the client requesting for configuration is the delivery serial number of the mobile phone.

The identity authentication module 208 is used to search the identification information about the client requesting for configuration that bound with the payment account, and use the identification information about the client requesting for configuration to carry out identity authentication on the client that sends the payment request, and if the identity authentication is passed, notify the payment unit to send the payment account information, the user information and the order information to the third-party transaction system, such that the third-party transaction system accomplishes the payment flow of the order information using the payment account information and the user information.

In some embodiments, a server may authenticate the payment account information and user information requested by a client for configuration, carry out configuration verification on the verification information containing a payment key submitted by the client, and bind a payment account allocated for the client with the payment account information, the user information and the payment key; a series of processes, such as authentication and verification, may effectively ensure information security during information configuration; the binding processing may avoid the user carrying out information input repeatedly during the transaction payment process that is initiated after information configuration, thus simplifying the transaction payment flow and improving the transaction payment efficiency; and the payment key may be set by the client during information configuration, which improves the security and reliability of the transaction payment initiated after information configuration.

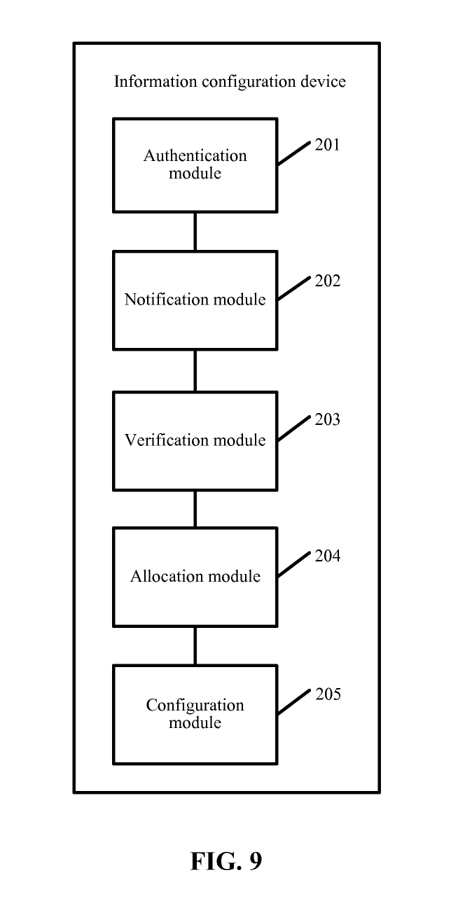

The modules in the information configuration device shown in the above-mentioned FIG. 9 and FIG. 10 will be described in detail with reference to FIG. 11 to FIG. 13.

Please refer to FIG. 11a, which is a block diagram of an authentication module provided in some embodiments. The authentication module 201 may comprise a first search unit 2101 and a first authentication unit 2102.

The first search unit 2101 is used to search the third-party transaction system to which the payment account information belongs.

The first search unit 2101 searches for the payment account information is the transaction account information issued by which third-party transaction system, e.g., given that the payment account information is XX bank credit card information, the first search unit 2101 may find that XX bank system is the third-party transaction system to which the payment account information belongs.

The first authentication unit 2102 is used to call an interface of the third-party transaction system, and carries out identity authentication on the payment account information and user information.

The third-party transaction system may provide an API interface, and the server calls the API interface provided by the third-party transaction system, so as to carry out identity authentication on the payment account information and user information, i.e., authenticating whether a user corresponding to the user information has payment rights of the payment account information; e.g., according to the example in this embodiment, the first authentication unit 2102 may call an API interface of XX bank system, and authenticate whether the user corresponding to the user information is a card holder of the XX bank credit card, so as to determine whether the user corresponding to the user information has payment rights of the XX bank credit card.

Please refer to FIG. 11b, which is a block diagram of an authentication module provided in some embodiments. The authentication module 201 may comprise a second search unit 2111, a second authentication unit 2112 and a result receiving unit 2113.

The second search unit 2111 is used to search the third-party transaction system to which the payment account information belongs.

The second search unit 2111 searches for the payment account information is the transaction account information issued by which third-party transaction system, e.g., given that the payment account information is XX bank credit card information, the second search unit 2111 may find that XX bank system is the third-party transaction system to which the payment account information belongs.

The second authentication unit 2112 is used to send the payment account information and the user information to the third-party transaction system, such that the third-party transaction system may carry out identity authentication on the payment account information and user information.

According to the example in this embodiment, the third-party transaction system may authenticate whether the user corresponding to the user information is a card holder of the XX bank credit card, so as to determine whether the user corresponding to the user information has payment rights of the XX bank credit card.

The result receiving unit 2113 is used to receive the authentication result returned from the third-party transaction system. The authentication result comprises successful authentication or failed authentication.

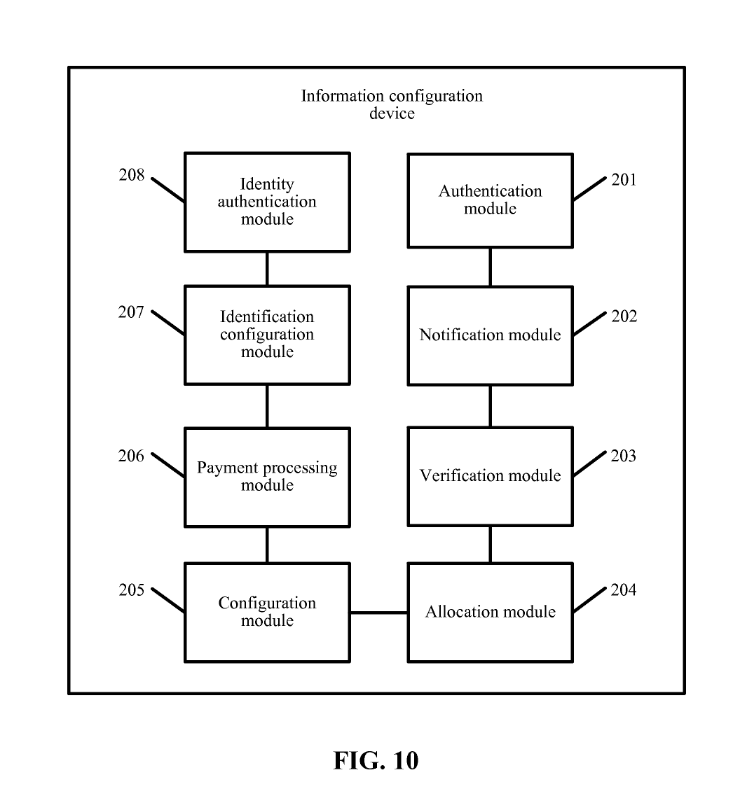

Please refer to FIG. 12, which is a block diagram of a verification module provided in some embodiments. The verification module 203 may comprise a parsing unit 2301, a comparison unit 2302 and a result determination unit 2303.

The parsing unit 2301 is used to parse the confirmation verification code out of the verification information submitted by the client.

The parsing unit 2301 may parse and separate the verification information submitted by the client to obtain the confirmation verification code and the payment key.

The comparison unit 2302 is used to compare the confirmation verification code with the preset configuration verification code.

The comparison unit 2302 is used to compare the confirmation verification code with the preset configuration verification code, comprising the following several cases:

in the first case: given that the preset configuration verification code is at least one of digits, letters and a graph, the comparison unit 2302 may compare whether the confirmation verification code is completely identical to the preset configuration verification code, e.g., if the preset configuration verification code is “35LM (capital)” and the confirmation verification code is “35LM (capital)”, the comparison unit 2302 determines that they are completely identical by comparison to confirm that they match each other.

In the second case: given that the preset configuration verification code is at least one of digits, letters and a graph, the comparison unit 2302 may compare whether the confirmation verification code is substantially identical to the preset configuration verification code, e.g., if the preset configuration verification code is “35LM (capital)” and the confirmation verification code is “35lm (lowercase)”, the comparison unit 2302 determines that they are substantially identical by comparison to confirm that they match each other; alternatively, if the preset configuration verification code is a graph of “♦ (solid)” and the confirmation verification code is a graph of “⋄ (hollow)”, the comparison unit 2302 determines that they are substantially identical by comparison to confirm that they match each other.

In the third case: given that the preset configuration verification code is a formula, the comparison unit 2302 may compare whether the computation results of the confirmation verification code and the preset configuration verification code are the same, e.g., if the preset configuration verification code is “3+2=?” and the confirmation verification code is “5”, the comparison unit 2302 determines that the computation results of the confirmation verification code and the preset configuration verification code are the same by comparison to confirm that they match each other.

The result determination unit 2303 is used to determine that verification succeeds if the confirmation verification code and the preset configuration verification code match each other, or else, to determine that verification has failed.

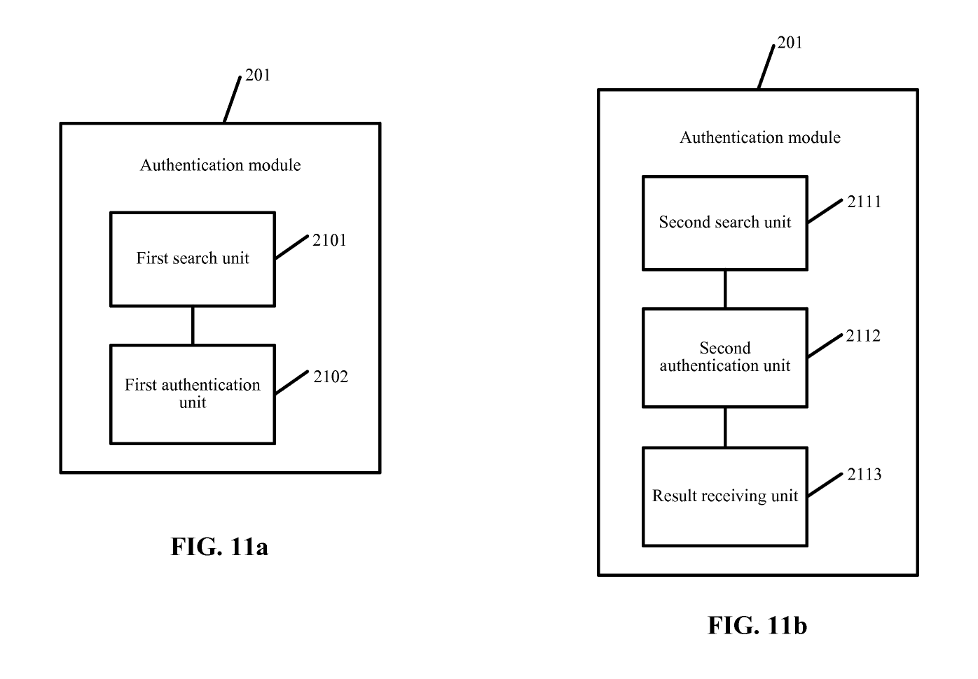

Please refer to FIG. 13, which is a block diagram of a payment processing module provided in some embodiments. The payment processing module 206 may comprise a binding search unit 2601, a payment authentication unit 2602 and a payment unit 2603.

The binding search unit 2601 is used to search the payment account information, the user information and the payment key bound with the payment account.

The payment authentication unit 2602 is used to authenticate the transaction key using the payment key.

The payment authentication unit 2602 judges whether the payment key is identical to the transaction key, and if the payment key is identical to the transaction key, the authentication is passed; or else, the authentication has failed. The payment authentication unit 2602 carries out payment verification on the current transaction key in this transaction payment flow using a payment key that is pre-bound by the user, which can effectively ensure security during this transaction payment process.

The payment unit 2603 is used to send the payment account information, the user information and the order information to the third-party transaction system if the authentication is passed, such that the third-party transaction system may accomplish a payment flow of the order information using the payment account information and the user information.

With the description of the embodiments shown in the above-mentioned FIG. 11 to FIG. 13, in some embodiments, a server may authenticate the payment account information and user information requested by a client for configuration, carry out configuration verification on the verification information containing a payment key submitted by the client, and bind a payment account allocated for the client with the payment account information, the user information and the payment key; a series of processes, such as authentication and verification, may effectively ensure information security during information configuration; the binding processing may avoid the user carrying out information input repeatedly during the transaction payment process that is initiated after information configuration, thus simplifying the transaction payment flow and improving the transaction payment efficiency; and the payment key may be set by the client during information configuration, which improves the security and reliability of the transaction payment initiated after information configuration.

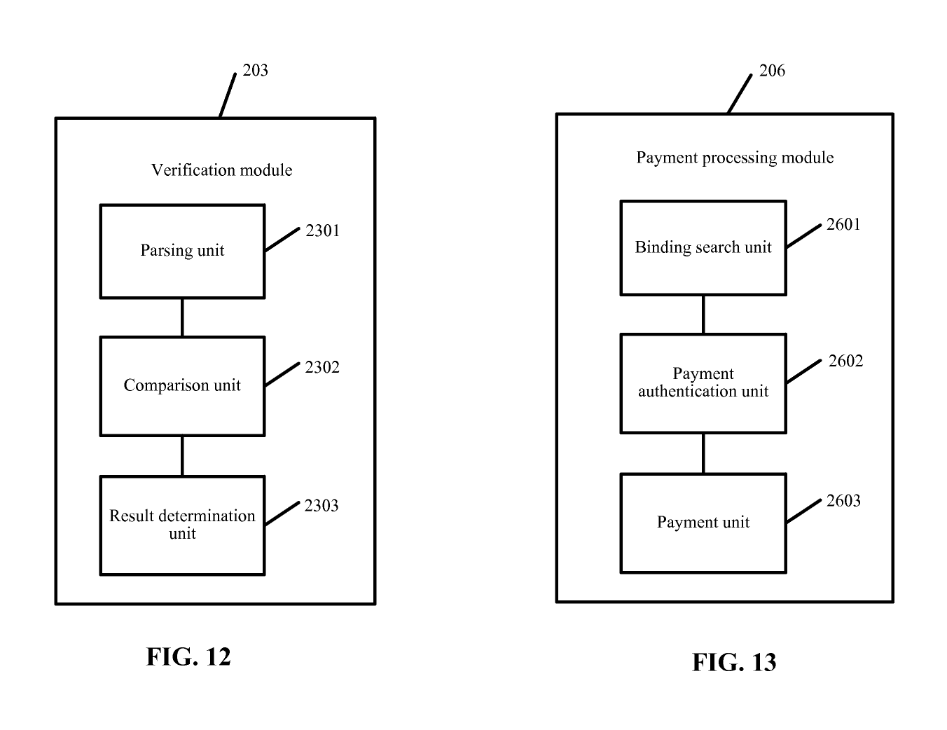

Please refer to FIG. 14, which is a block diagram of a server provided in some embodiments. The server of the embodiment of the present technique comprises at least one processor 2001, e.g., a CPU, at least one communication bus 2002, at least one network interface 2003, and a memory 2004. The communication bus 2002 is used to implement connections and communications among these elements. Optionally, the network interface 2003 may comprise standard wired interfaces and wireless interfaces (such as WI-FI and mobile communication interface). The memory 2004 may be a high speed random access memory, or may be a non-volatile memory, e.g., at least one magnetic disk memory. Optionally, the memory 1004 may also be at least one memory device located away from the above-mentioned processor 2004. As shown in FIG. 14, the memory 2004 for being used as a computer storage medium stores operating systems and network communication modules therein, and also stores information configuration programs and other programs therein.

Specifically, the processor 2001 may be used to call the information configuration program stored in the memory 2004, and executes the following steps:

Authenticating the payment account information and user information requested for configuration by a client, and sending verification notification to the client after the authentication succeeds;

Carrying out configuration verification on the verification information containing a payment key that is submitted by the client according to the verification notification, and allocating a payment account for the client after the verification succeeds; and

Binding the payment account with the payment account information and user information and the payment key.

In some embodiments, a server may authenticate the payment account information and user information requested by a client for configuration, carry out configuration verification on the verification information containing a payment key submitted by the client, and bind a payment account allocated for the client with the payment account information, the user information and the payment key; a series of processes, such as authentication and verification, may effectively ensure information security during information configuration; the binding processing may avoid the user carrying out information input repeatedly during the transaction payment process that is initiated after information configuration, thus simplifying the transaction payment flow and improving the transaction payment efficiency; and the payment key may be set by the client during information configuration, which improves the security and reliability of the transaction payment initiated after information configuration.

The processor 2001 may be used to perform other functions of the server described with respect to FIGS. 1-6B.

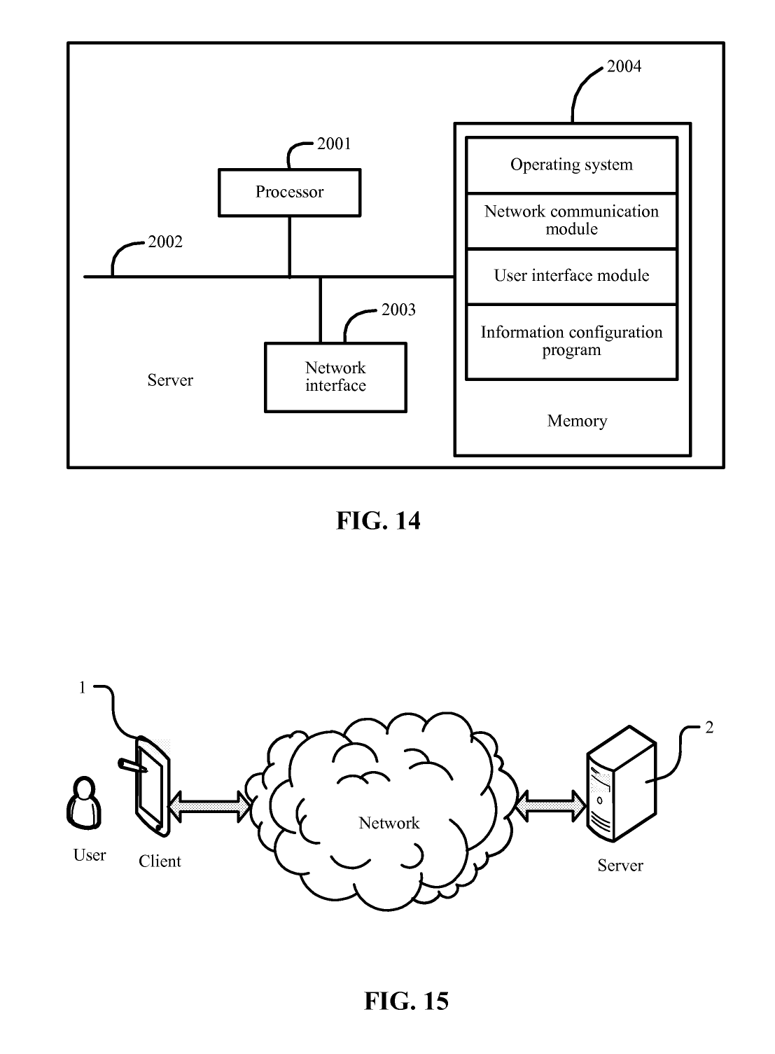

Please refer to FIG. 15, which is a graphical representation of an information configuration device provided in some embodiments. The system comprises a client 1 and a server 2. The structure of the client 1 may refer to the description of the embodiment shown in FIG. 8, and the structure of the server 2 may refer to the description of the embodiment shown in FIG. 14.

Please refer to FIG. 15 again, the client 1 and the server 2 are connected with each other via a network, and interact with each other to implement the information configuration flow shown in any one of the embodiments shown in FIG. 1 to FIG. 6B. The client 1 comprises an information configuration device, and the structure of the information configuration device may refer to the relevant description of the embodiments shown in FIG. 7A and FIG. 7B, which is unnecessary to describe here in details. The server 2 comprises another information configuration device, and the structure of the information configuration device may refer to the relevant description of the embodiments shown in FIG. 9 to FIG. 13, which is unnecessary to describe here in details.

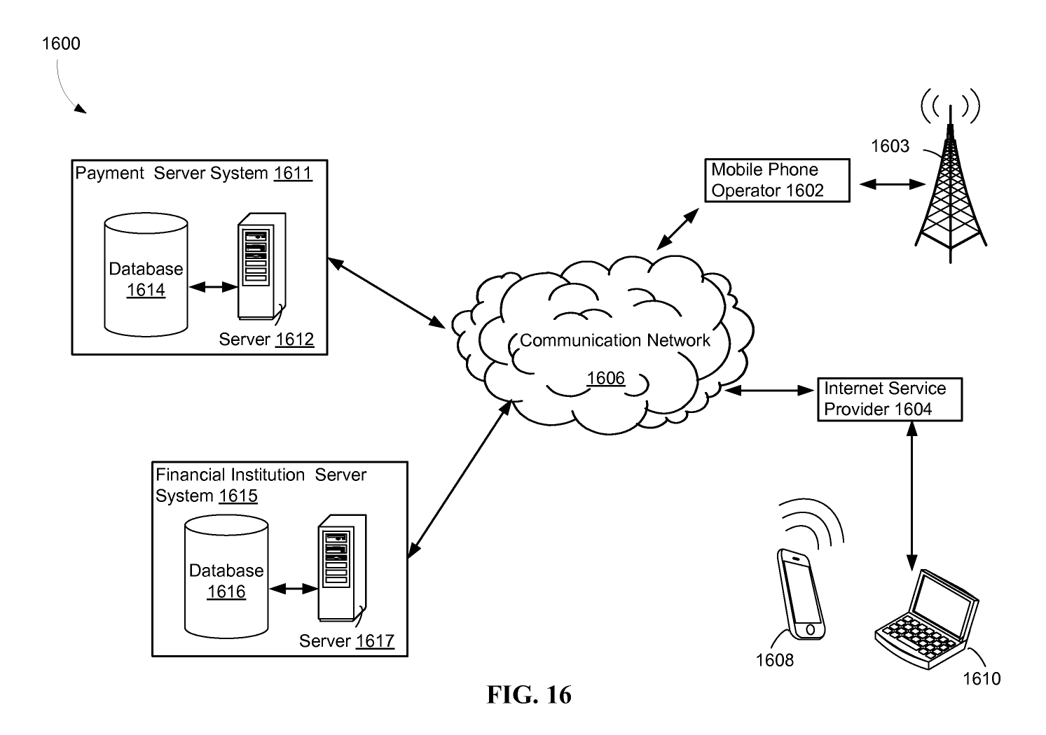

FIG. 16 is a block diagram of a client-server environment 1600 for authorizing a payment transaction, in accordance with some embodiments of the present application. While certain specific features are illustrated, those skilled in the art will appreciate from the present disclosure that various other features have not been illustrated for the sake of brevity and so as not to obscure more pertinent aspects of the implementations disclosed herein. To that end, the client-server environment 1600 includes one or more mobile phone operators 1602, one or more internet service providers 1604, and a communications network 1606.

The mobile phone operator 1602 (e.g., wireless carrier), and the Internet service provider 1604 are capable of being connected to the communication network 1606 in order to exchange information with one another and/or other devices and systems. Additionally, the mobile phone operator 1602 and the Internet service provider 1604 are operable to connect client devices to the communication network 1606 as well. For example, a smart phone 1608 is operable with the network of the mobile phone operator 1602, which includes for example, a base station 1603. Similarly, for example, a laptop computer 1610 (or tablet, desktop, smart television, workstation or the like) is connectable to the network provided by an Internet service provider 1604, which is ultimately connectable to the communication network 1606.

The communication network 1606 may be any combination of wired and wireless local area network (LAN) and/or wide area network (WAN), such as an intranet, an extranet, including a portion of the Internet. It is sufficient that the communication network 1606 provides communication capability between client devices (e.g., smart phones 1608 and personal computers 1610) and servers. In some implementations, the communication network 1606 uses the HyperText Transport Protocol (HTTP) to transport information using the Transmission Control Protocol/Internet Protocol (TCP/IP). HTTP permits a client device to access various resources available via the communication network 1606. However, the various implementations described herein are not limited to the use of any particular protocol.

In some implementations, the client-server environment 1600 further includes a payment server system 1611. Within the payment server system 1611, there is a server computer 1612 (e.g., a network server such as a web server) for receiving and processing data received from the client device 1608/1610 (e.g., a payment request, or payment key). In some implementations, the payment server system 1611 stores (e.g., in a database 1614) and maintains payment profile information (e.g., payment keys, device IDs) corresponding to one or more user accounts for users of client devices 1608/1610 or an application running on client device 1608/1610. In some embodiments, the payment server system 1611 is part of a general mobile payment system or a general mobile banking/finance system or a general e-commerce system.

In some implementations, the payment server system 1611 sends and receives various communications to and from a client device 1608/1610. In some embodiments, these communications or the information in these communications are stored and retrieved from database 1614. In some embodiments, the payment server system 1611 receives a payment request, payment key and predetermined device identification data, from a first user of client device 1608/1610 (e.g., request to make a purchase along with a payment password) and in some embodiments, the payment server system 1611 determines whether the predetermined device identification data corresponds to a registered user device associated with a payment account identified by the payment request. In some embodiments, the payment server system 1611 communicates with another server system or computer system, such as financial institution server system 1615 to determine if the password entered is a valid password corresponding to the selected payment account (e.g., checking if a debit PIN entered for a bank card matches the debit PIN stored at the financial server system). In some embodiments, financial institution server system 1615 comprises one or more databases 1616 and one or more servers 1617. In some embodiments, the payment server system 1611 stores (e.g., in database 1614) payment information (e.g., payment card number, name on payment card, PIN, billing address etc.) and payment key information (e.g., a compact 6-digit password and a full-length alpha-numeric password) for one or more payment cards associated with a first user account.

Those skilled in the art will appreciate from the present disclosure that any number of such devices and/or systems may be provided in a client-server environment, and particular devices may be altogether absent. In other words, the client-server environment 1600 is merely an example provided to discuss more pertinent features of the present disclosure. Additional server systems, such as domain name servers and client distribution networks may be present in the client-server environment 1600, but have been omitted for ease of explanation.

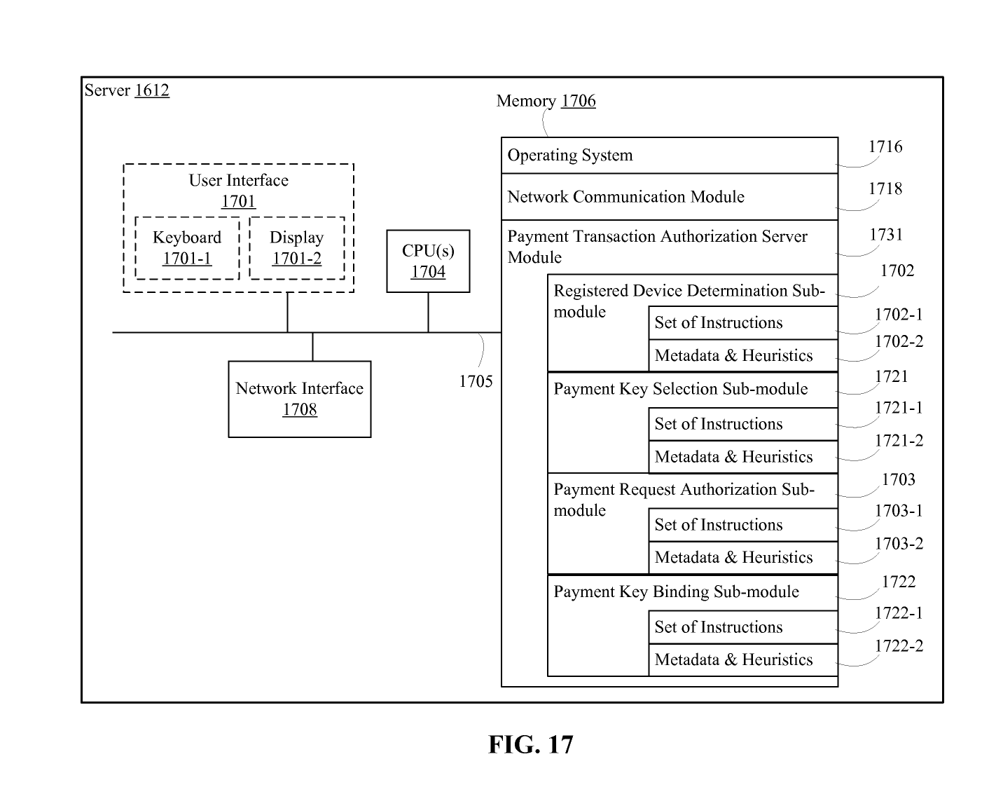

FIG. 17 is a diagram of an example implementation of the payment server 1612, in accordance with some implementations of the present application. While certain specific features are illustrated, those skilled in the art will appreciate from the present disclosure that various other features have not been illustrated for the sake of brevity and so as not to obscure more pertinent aspects of the implementations disclosed herein.

Server 1612 includes one or more processing units (CPU's) 1704, one or more network or other communications interfaces 1708, an optional user interface 1701 (optionally comprising elements such as a keyboard 1701-1 or display 1701-2), memory 1706, and one or more communication buses 1705 for interconnecting these and various other components. The communication buses 1705 may include circuitry (sometimes called a chipset) that interconnects and controls communications between system components. Memory 1706 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 1706 may optionally include one or more storage devices remotely located from the CPU(s) 1704. Memory 1706, including the non-volatile and volatile memory device(s) within memory 1706, comprises a non-transitory computer readable storage medium.

In some implementations, memory 1706 or the non-transitory computer readable storage medium of memory 1706 stores the following programs, modules and data structures, or a subset thereof including an operating system 1716, a network communication module 1718, and a payment transaction authorization server module 1731.

The operating system 1716 includes procedures for handling various basic system services and for performing hardware dependent tasks.

The network communication module 1718 facilitates communication with other devices via the one or more communication network interfaces 1708 (wired or wireless) and one or more communication networks, such as the internet, other wide area networks, local area networks, metropolitan area networks, and so on.

In some implementations, the payment transaction authorization server module 1731 includes a registered device determination sub-module 1702 for receiving, a payment request, a payment key and predetermined device identification data entered by a user at a client device 1608/1610 and determining whether the predetermined device identification data corresponds to a registered user device associated with a payment account identified by the payment request. To this end, the registered device determination sub-module 1702 includes a set of instructions 1702-1 and, optionally, metadata 1702-2. In some implementations, the payment transaction authorization server module 1731 includes a payment key selection sub-module 1721 having a set of instructions 1721-1 (e.g., to select a corresponding reference payment key from multiple reference payment keys stored for a respective payment account, in order to verify the payment key received from the client device) and, optionally, metadata 1721-2, as well as a payment request authorization sub-module 1703 having a set of instructions 1703-1 (e.g., for authorizing the payment request in accordance with one or more determinations) and optionally metadata 1703-2. In some implementations, the payment transaction authorization server module 1731 includes a payment key binding sub-module 1722 having a set of instructions 1722-1 (e.g., for associating a compact payment key with a payment account) and, optionally, metadata 1722-2. The server may also include other modules for implementing other functions of the server described with respect to FIGS. 1-6B.

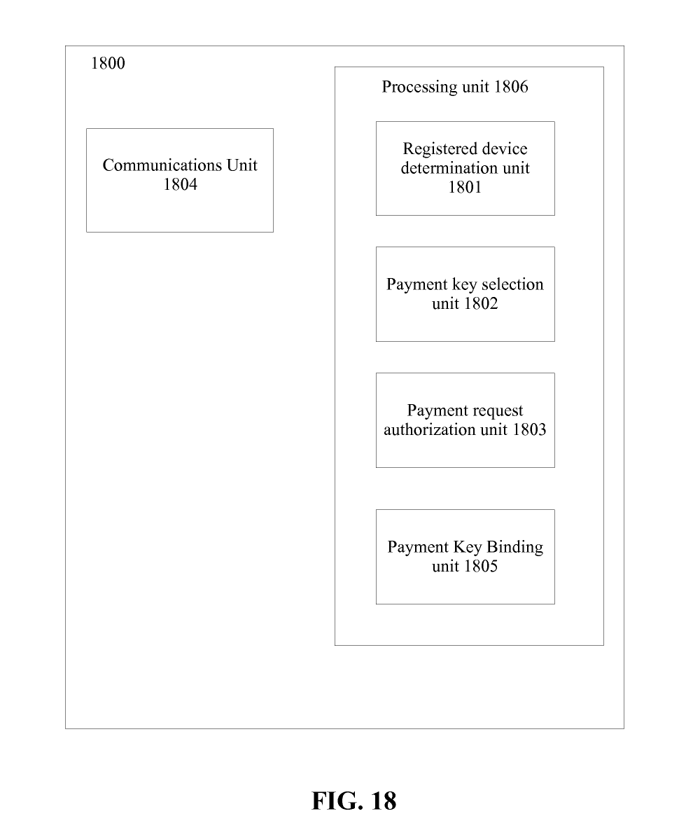

FIG. 18 is a structural diagram of a realization apparatus 1800 of authorizing a payment transaction in accordance with some implementations of the present application.

As is shown in FIG. 18, this device includes: a communications unit 1804, and a processing unit 1806 comprising a registered device determination unit 1801, payment key selection unit 1802, payment request authorization unit 1803, and payment key binding unit 1805, among which:

Registered device determination unit 1801: configured to receive, a payment request, a payment key and predetermined device identification data entered by a user at a client device 1608/1610 and determine whether the predetermined device identification data corresponds to a registered user device associated with a payment account identified by the payment request;

Payment key selection unit 1802: configured to select a corresponding reference payment key from multiple reference payment keys stored for a respective payment account, in order to verify the payment key entered by the user;

Payment request authorization unit 1803: configured to authorize the payment request in accordance with one or more determinations;

Payment key binding unit 1805: configured to bind one or more passwords or payments keys with one or more payment accounts (e.g., associating a compact payment key with a payment account).

Communications unit 1804 is configured to send and receive communications (e.g., server 1612 to and from client device 1608/1610 or server 1612 to and from financial institution server 1615).

It is acceptable to integrate the device shown in FIG. 18 into hardware entities of a variety of networks. For example, the realization device for identity authentication is allowed to be integrated into: server systems including mainframes, PC computers, portable electronic devices, commercial/enterprise servers etc.

While particular embodiments are described above, it will be understood it is not intended to limit the technique to these particular embodiments. On the contrary, the technique includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The foregoing description, for purpose of explanation, has been described with reference to specific embodiments. However, the illustrative discussions above are not intended to be exhaustive or to limit the technique to the precise forms disclosed. Many modifications and variations are possible in view of the above teachings. The embodiments were chosen and described in order to best explain the principles of the technique and its practical applications, to thereby enable others skilled in the art to best utilize the technique and various embodiments with various modifications as are suited to the particular use contemplated.

What is claimed is:

1. A method of authorizing a payment transaction, comprising:
at a payment server having one or more processors, and memory for storing programs to be executed by the one or more processors:
receiving, from a user device, a payment request and a payment key entered by a user at the user device;
receiving, from the user device and with the payment key, predetermined device identification data for the user device;
determining whether the predetermined device identification data corresponds to a registered user device associated with a payment account identified by the payment request; and
in accordance with an outcome of the determining, selecting a corresponding reference payment key from multiple reference payment keys stored for the payment account, to verify the payment key entered by the user.

2. The method of claim 1, wherein selecting the corresponding reference payment key from the multiple reference payment keys stored for the payment account in accordance with the outcome of the determining further comprises:
in accordance with a determination that the predetermined device identification data corresponds to a first registered user device associated with the payment account:
selecting a first reference payment key corresponding to the first registered user device of the payment account to verify the payment key entered by the user.

3. The method of claim 2, wherein the first registered user device is associated with at least a compact payment key and a full-length payment key, and the compact payment key is selected as the first reference payment key, and wherein the method further comprises:
in accordance with a determination that the payment key entered by the user matches the compact payment key corresponding to the first registered user device:
authorizing the payment request.

4. The method of claim 3, further comprising:
in accordance with a determination that the payment key entered by the user does not match the compact payment key corresponding to the first registered user device:
comparing the payment key entered by the user to the full-length payment key corresponding to the payment account; and
in accordance with a determination that the payment keyword entered by the user matches the full-length payment key:
authorizing the payment request.

5. The method of claim 3, wherein the compact payment key is a substring of the full-length payment key.

6. The method of claim 2, wherein the first registered user device is associated with a full-length payment key and the method further comprises:
in accordance with the determination that the predetermined device identification data corresponds to the first registered user device associated with the payment account:
comparing the payment key entered by the user against a predetermined substring of the full-length payment key; and
in accordance with a determination that the payment key entered by the user matches the predetermined substring of the full-length payment key:
authorizing the payment request.

7. The method of claim 1, wherein the multiple reference payment keys include at least a full-length payment key associated with the payment account, and one or more compact payment keys associated with one or more registered user devices of the payment account, and wherein selecting the corresponding reference payment key from the multiple reference payment keys stored for the payment account in accordance with the outcome of the determining further comprises:
in accordance with a determination that the predetermined device identification data does not correspond to any of the one or more registered devices associated with the payment account:
selecting the full-length payment key associated with the payment account to verify the payment key entered by the user.

8. The method of claim 1, further comprising:
prior to receiving the payment request:
receiving from the user device, a first password binding request for the payment account, wherein the first password binding request comprises the predetermined device identification data corresponding to the user device, and a compact payment key;
in response to the first password binding request, associating the compact payment key and the predetermined device identification data with the payment account;
receiving a second password binding request, wherein the second password binding request comprises a full-length payment key for the payment account, and wherein the full-length payment key has a higher security strength than the compact payment key; and
in response to the second password binding request, associating the full-length payment key with the payment account.

9. A server, comprising:
one or more processors;
memory having instructions stored thereon, the instructions, when executed by the one or more processors, cause the processors to perform operations comprising:
receiving, from a user device, a payment request and a payment key entered by a user at the user device;
receiving, from the user device and with the payment key, predetermined device identification data for the user device;
determining whether the predetermined device identification data corresponds to a registered user device associated with a payment account identified by the payment request; and
in accordance with an outcome of the determining, selecting a corresponding reference payment key from multiple reference payment keys stored for the payment account, to verify the payment key entered by the user.

10. The server of claim 9, wherein selecting the corresponding reference payment key from the multiple reference payment keys stored for the payment account in accordance with the outcome of the determining further comprises:
in accordance with a determination that the predetermined device identification data corresponds to a first registered user device associated with the payment account:
selecting a first reference payment key corresponding to the first registered user device of the payment account to verify the payment key entered by the user.

11. The server of claim 10, wherein the first registered user device is associated with at least a compact payment key and a full-length payment key, and the compact payment key is selected as the first reference payment key, and wherein the operations further comprise:
in accordance with a determination that the payment key entered by the user matches the compact payment key corresponding to the first registered user device:
authorizing the payment request.

12. The server of claim 11, wherein the operations further comprise:
in accordance with a determination that the payment key entered by the user does not match the compact payment key corresponding to the first registered user device:
comparing the payment key entered by the user to the full-length payment key corresponding to the payment account; and
in accordance with a determination that the payment keyword entered by the user matches the full-length payment key:
authorizing the payment request.

13. The server of claim 11, wherein the compact payment key is a substring of the full-length payment key.

14. The server of claim 10, wherein the first registered user device is associated with a full-length payment key and the operations further comprise:
in accordance with the determination that the predetermined device identification data corresponds to the first registered user device associated with the payment account:
comparing the payment key entered by the user against a predetermined substring of the full-length payment key; and
in accordance with a determination that the payment key entered by the user matches the predetermined substring of the full-length payment key:
authorizing the payment request.

15. The server of claim 9, wherein the multiple reference payment keys include at least a full-length payment key associated with the payment account, and one or more compact payment keys associated with one or more registered user devices of the payment account, and wherein selecting the corresponding reference payment key from the multiple reference payment keys stored for the payment account in accordance with the outcome of the determining further comprises:
in accordance with a determination that the predetermined device identification data does not correspond to any of the one or more registered devices associated with the payment account:
selecting the full-length payment key associated with the payment account to verify the payment key entered by the user.

16. The server of claim 9, wherein the operations further comprise:
prior to receiving the payment request:
receiving from the user device, a first password binding request for the payment account, wherein the first password binding request comprises the predetermined device identification data corresponding to the user device, and a compact payment key;
in response to the first password binding request, associating the compact payment key and the predetermined device identification data with the payment account;
receiving a second password binding request, wherein the second password binding request comprises a full-length payment key for the payment account, and wherein the full-length payment key has a higher security strength than the compact payment key; and
in response to the second password binding request, associating the full-length payment key with the payment account.

17. A non-transitory computer readable storage medium storing one or more programs, the one or more programs comprising instructions, which when executed by a server, cause the server to:
receive, from a user device, a payment request and a payment key entered by a user at the user device;
receive, from the user device and with the payment key, predetermined device identification data for the user device;
determine whether the predetermined device identification data corresponds to a registered user device associated with a payment account identified by the payment request; and
in accordance with an outcome of the determining, select a corresponding reference payment key from multiple reference payment keys stored for the payment account, to verify the payment key entered by the user.

18. The non-transitory computer readable storage medium of claim 17, wherein selecting the corresponding reference payment key from the multiple reference payment keys stored for the payment account in accordance with the outcome of the determining further comprises:
in accordance with a determination that the predetermined device identification data corresponds to a first registered user device associated with the payment account:
select a first reference payment key corresponding to the first registered user device of the payment account to verify the payment key entered by the user.

19. The non-transitory computer readable storage medium of claim 18, wherein the first registered user device is associated with at least a compact payment key and a full-length payment key, and the compact payment key is selected as the first reference payment key, and further comprising instructions that cause the device to:
in accordance with a determination that the payment key entered by the user matches the compact payment key corresponding to the first registered user device:
authorize the payment request.

20. The non-transitory computer readable storage medium of claim 18, wherein the first registered user device is associated with a full-length payment key and further comprising instructions that cause the device to:
in accordance with the determination that the predetermined device identification data corresponds to the first registered user device associated with the payment account:
compare the payment key entered by the user against a predetermined substring of the full-length payment key; and
in accordance with a determination that the payment key entered by the user matches the predetermined substring of the full-length payment key:
authorize the payment request.
